(19) United States
(12) Patent Application Publication
(10) Pub. No.: US 2026/0102751 A1
(43) Pub. Date: Apr. 16, 2026

(54) HIGH TEMPERATURE AND CORROSION RESISTANT SPRAYER

(71) Applicant: Polar Sapphire Ltd., Toronto (CA)

(72) Inventors: Kevin Vickers, Toronto (CA); Nicholas Ekl, Toronto (CA); Scott Nichol, Toronto (CA)

(21) Appl. No.: 19/354,021

(22) Filed: Oct. 9, 2025

Related U.S. Application Data
(60) Provisional application No. 63/705,845, filed on Oct. 10, 2024.

(51) Int. Cl. B01J 4/00; B01J 8/00; B01J 19/26; B05B 7/04; C01F 7/30

(52) U.S. Cl. CPC B01J 4/002; B01J 8/004; B01J 19/26; B05B 7/0483; C01F 7/30; B01J 2204/002; B01J 2208/00752

(57) ABSTRACT

A spray nozzle comprises an elongated cylinder comprising a first end, an opposite second end, and a conduit extending between the first end and the second end, wherein the first end is configured for receiving a liquid based composition and a compressed gas, wherein the second end comprises at least one outlet for the liquid based composition and the compressed air, and wherein the elongated cylinder is formed from a first ceramic material that can withstand temperatures of at least 300° C. and that will not corrode when exposed to the liquid based composition.

### CROSS-REFERENCE TO RELATED APPLICATION

This application claims the benefit of U.S. Provisional Application No. 63/705,845 filed Oct. 10, 2024, the entire contents of which are incorporated by reference herein.

### BACKGROUND

High-purity aluminum oxide or alumina powder can be used to make many different structures in various fields, including, but not limited to: translucent tubes for high-pressure sodium lamps, sapphires for watch covers, high-strength ceramic tools, abrasives for magnetic tape, light emitting diodes as a substrate for GaN, silicon microchip wafers for optic-electronics, windows and cowls for aircrafts, protective windows for car headlamps, cell phones and other electronic devices, stop signals, surgery scalpels, micro-optical elements of medical fiber-optic probes, optical scanners for bar codes, ultraviolet CD and DVD optical systems, prisms, lenses, optical plates, optical systems of visual and IR diapasons, cell phone, mobile devices and fiber-optic system display windows, equipment for chemical manufacturing in aggressive and high-temperature environments: tubes, crucibles, funnels, chemical glassware, abrasives, battery components, bearings and jewelry stones.

Currently, the most common methods of making high-purity alumina for manufacturing sapphire for LED substrates are aluminum-ammonium-sulfate thermal decomposition, aluminum-ammonium-carbonate thermal decomposition and aluminum-isopropoxide hydrolyzation. The high-purity alumina is then used in the Verneuil process to make crackle or compressed into densified pucks, granules or beads for melting in a sapphire ingot furnace.

Recently, there has been some advancement in a process comprising reacting high-purity aluminum metal with an acid in the presence of water to provide an aluminum salt solution. The aluminum salt can then be calcinated in a high-purity crucible or furnace to produce high-purity aluminum oxide. However, using aluminum as the starting raw material for manufacturing high purity aluminum oxide is very difficult because it is difficult to control the reaction rate of the acid with the aluminum. High purity aluminum reacts very slowly with acid and then can very quickly accelerate into a very quick exothermic reaction. Moreover, at each step of the process the feedstock or reaction product can be contaminated by the reaction vessel, furnace or holding container.

### SUMMARY

The present disclosure describes spraying apparatuses that can be used to spray an acidic solution into a furnace heated to a very high temperature of at least about 450° C., and potentially up to a temperature of 1600° C. or more. In particular, the spraying apparatuses described herein have been found to be particularly useful for spraying a high-purity aluminum salt solution, such as high-purity polyaluminum chloride (PAC), as a fine mist into a furnace configured for calcinating the aluminum salt solution into high-purity aluminum oxide powder, even when the aluminum salt solution is acidic (and therefore corrosive to many materials) as a result of the process of forming the high-purity aluminum salt solution. The present disclosure also describes methods of forming a high-purity aluminum oxide using the spraying apparatuses described herein.

In an example, the present disclosure describes a spray nozzle comprising an elongated cylinder comprising a first end, an opposite second end, and a conduit extending between the first end and the second end, wherein the first end is configured for receiving a liquid based composition and a compressed gas, wherein the second end comprises at least one outlet for the liquid based composition and the compressed air, and wherein the elongated cylinder is formed from a first ceramic material that can withstand temperatures of at least 500° C. and that will not corrode when exposed to the liquid based composition.

### BRIEF DESCRIPTION OF THE FIGURES

The drawings illustrate generally, by way of example, but not by way of limitation, various embodiments discussed in the present document.

FIG. 1 is a flow diagram of a non-limiting example process that includes forming a high-purity aluminum salt solution and spraying the aluminum salt solution into a furnace to produce a high-purity aluminum oxide powder.

FIG. 2 is a flow diagram of another non-limiting example process that includes forming a high-purity aluminum salt solution and spraying the aluminum salt solution into a furnace to produce a high-purity aluminum oxide powder.

FIG. 3 is a disassembled elevation view of a first example spray nozzle and a venturi fixture for spraying a potentially corrosive liquid, solution, or slurry into a high-temperature vessel that could be used, for example, for spraying the aluminum salt solution into furnace in the processes of FIGS. 1 and 2.

FIG. 4 is a cross-sectional view of the example spray nozzle and the venturi fixture of FIG. 3 with the venturi fixture and the spray nozzle assembled.

FIG. 5 is a close-up cross-sectional view of the engagement and cement coupling of a spray tip and an elongated atomizing tube of the spray nozzle of FIGS. 3 and 4, taken along line 5-5 in FIG. 4.

FIG. 6 is a perspective view of a second example spray nozzle for spraying a potentially corrosive liquid, solution, or slurry into a high-temperature vessel that could be used, for example, for spraying the aluminum salt solution into furnace in the processes of FIGS. 1 and 2.

FIG. 7 is an elevation view of the example spray nozzle of FIG. 6.

FIG. 8 is a cross-sectional view of the example spray nozzle of FIG. 6.

FIG. 9 is a close-up cross-section view of a first outlet for the liquid, solution, or slurry and of a second outlet for compressed air at a distal end of the example spray nozzle of FIG. 6-8.

FIG. 10 is a cross-sectional view of an elongated cylinder portion of the example spray nozzle of FIG. 6-9 taken along line 10-10 in FIG. 8.

FIG. 11 is an end view of the distal end of the example spray nozzle of FIG. 6-10, showing the first and second outlets.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000, 1”” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%,, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Spray Roasting Process

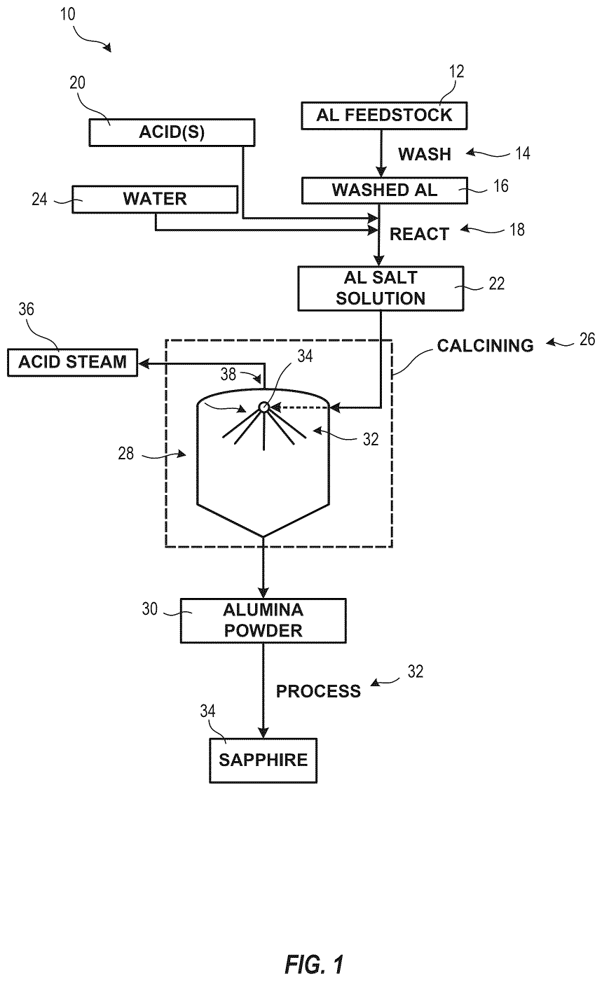

FIG. 1 shows a flow diagram of an example, non-limiting process 10 for producing aluminum oxide, and in particular for producing high-purity aluminum oxide such as synthetic sapphire. As used herein, the term “high-purity aluminum oxide” refers to aluminum oxide having a purity of about 4N (99.99% pure, with total impurities of 0.01%, or 100 ppm) or greater, such as 5N (99.999% pure, with total impurities of 0.001%, or 10 ppm) or greater, for example 6N (99.9999% pure, with total impurities of 0.0001%, or 1 ppm). In some examples, the term “high-purity aluminum oxide” refers to aluminum oxide having a purity in the range of from about 4N to about 6N.

The process 10 processes an aluminum metal feedstock 12 to produce aluminum oxide. The aluminum feedstock can have a purity of at least 99.9 at. % aluminum (e.g., 3N aluminum) or greater, such as 99.98 at. % aluminum or greater, for example 99.99 at. % aluminum (e.g., 4N aluminum) or greater, such as 99.995 at. % aluminum or greater, for example 99.998 at. % (e.g., 4.8N aluminum), such as 99.999 at. % (e.g., 5N aluminum) or greater. In an example, less than 0.02 wt. % of the total impurities are metallic impurities. In an example, each metallic element impurity is less than 0.01 at. %.

In an example, the aluminum feedstock 12 can comprise high-purity aluminum from the three-layer electrolytic process, also known as the Hoope process. High-purity scrap aluminum can also be used as the aluminum feedstock 12, such as electrical conducting wire, lithographic foil, or electrolytic capacitor aluminum foils. In an example, the aluminum feedstock 12 can have less than 20 ppmw metal and alkali impurities. In an example, the aluminum feedstock 12 can have less than about 30 ppmw total impurities. Forms of the aluminum feedstock 12 include, but are not limited to, ingots, sows, chunks, foil, wire, pyramids, powder, or other commercially available forms of aluminum metal or aluminum containing ore.

The process 10 can include, at step 14, optionally washing one or more surfaces of the aluminum feedstock 12 to provide a washed aluminum 16. The surfaces of the aluminum feedstock 12 can be washed 14 by treating the surfaces with a washing medium that can include, but is not limited to, one or more of water, an acid, a base, a soap or other surfactant, a solvent, or an alcohol. In an example, the aluminum feedstock 12 is washed 14 with hydrochloric acid (HCl) by contacting the aluminum feedstock 12 with the HCl for a time that is sufficient to clean the surfaces of the aluminum feedstock 12 to remove a specified portion of surface impurities. In an example, the aluminum feedstock 12 is contacted with a 5-20 wt. % HCl solution for from about 4 hours to about 24 hours, such as by placing the aluminum feedstock 12 in a washing vessel with the HCl solution for the specified period of time. The treated surfaces of the aluminum feedstock 12 can then be rinsed with water to provide the washed aluminum 16. In an example, the water used to rinse the aluminum feedstock 12 after washing 14 is high-purity water.

Next, the process 10 can include, at step 18, reacting aluminum, e.g., the aluminum feedstock 12 or the washed aluminum 16, with one or more acids 20 to provide a hydrated aluminum salt solution 22. Using aluminum as a starting raw material for manufacturing aluminum oxide can be difficult due to difficulties in controlling the reaction rate of the acid with the aluminum. High-purity aluminum reacts very slowly with acid, but the reaction can very quickly accelerate into a fast, exothermic reaction. Moreover, at each step of the process the feedstock can be contaminated by the reaction vessel, furnace or holding container. It can be important to control the reaction and temperature at each step to prevent contamination in the process in order to reach a high purity with a low cost. In the past it has been difficult to react high-purity aluminum economically in acid due to the fact that as the purity of the aluminum increases, the reaction of the aluminum with acid tends to slow down. Use of aluminum with very high surface area can also increase costs and potentially cause a runaway reaction due to the exothermic reaction.

Previous research on using acids to process ores high in aluminum content into aluminum oxide was primarily for the production of alumina for use in manufacturing primary aluminum. These processes are concerned with reaching the purity limits for the Hall-Heroult process, and do not purport to provide for the typical 4-6N purity requirements for producing a sapphire grade sufficient for LED substrates or other high-purity alumina applications. Conventionally-produced alumina powder for sapphire feedstock applications typically have at least the following impurity levels: Na<10 ppmw; Fe<5 ppmw; Si<10 ppmw; Ti<3 ppmw; Mg<2 ppm2; Ca<2 ppmw, and aluminum oxide purity of only about 99.99% (or 4N) purity. Higher alumina purities, such as 5N or greater, as feedstock for sapphire ingots can increase the yield and throughput for sapphire production processes.

In an example, the one or more acids 20 that are reacted with the aluminum feedstock 12 or the washed aluminum 16 can include, but are not limited to, one or any combination of sulfuric acid (H₂SO₄), nitric acid (HNO₃), phosphoric acid (H₃PO₄), hydrochloric acid (HCl), and hydrofluoric acid (HF). The acid can have a high purity, such as an acid having less than 1 ppmw impurities for all elements. In an example, the acid can comprise less than about 1 ppmw of Na, Ca, Li, Fe, Zn, Cu, Ti, Cr, K, and Mg. In an example, the acid can comprise less than about 0.2 ppmw of metallic impurities. The one or more acids 20 can be industrial-grade acids, such as industrial grade HCl, which has been purified via one or more of filtration, an ion-exchange process, distillation, and a diffusion dialysis process.

In an example, the one or more acids 20 can be diluted in water 24 so that the acid is at a specified concentration before or during the reaction 18. The one or more acids 20 and the water 24 can be added to the reaction 18 as the aluminum 16 is being leached. The water 24 can have a high purity, such water that has been purified by one or any combination of deionization, filtration, reverse osmosis, or distillation. As used herein, the term “high-purity water” can refer to water that has been purified by one or any combination of deionization, filtration, reverse osmosis, and distillation. In an example, “high-purity water” can be at least about 99.999 wt. % pure water. In some examples, “high-purity water” can have less than about 0.5 ppmw total impurities, such as less than about 0.2 ppmw total impurities. In an example, “high-purity water” can refer to water having a resistivity of 18 mega ohms·centimeter at 25° C. (MΩ·cm at 25° C.) or greater.

In an example, the hydrated aluminum salt solution 22 that is formed from the reaction 18 of the one or more acids 20 and the aluminum 16 in the presence of the water 24 comprises hydrated aluminum salt in water. The reaction 18 of the one or more acids 20 and the aluminum 16 can be referred to as leaching the aluminum 16. The aluminum 16 can be dissolved in the acid 20 to form the hydrated aluminum salt solution 22. The one or more acids 20 and the water 24 can be added in a sufficient amount so that substantially all the hydrated aluminum salt 22 can be dissolved in the liquid. Additional water having a high purity can be added in the form of a diluted high-purity acid or straight high-purity water. In examples where the acid 20 comprises HCl, the hydrated aluminum salt of the hydrated aluminum salt solution 22 comprises hydrated aluminum chlorohydrate, also referred to as polyaluminum chloride (PAC), which is a group of aluminum salts having the general formula AlₙCl₍₃ₙ₋ₘ₎(OH)ₘ.

The reaction can be run until all or substantially all of the available hydrogen from the acid 20 is released as hydrogen gas (H₂). The hydrated aluminum salt solution 22, such as polyaluminum chloride, which is formed by the reaction 18 can have a density of from about 1.25 grams/cm³ (“g/cc”) to about 1.37 g/cc once all the acid 20 has been reacted. The reaction 18 can take from about 6 hours to about 72 hours for all the acid 20 to be reacted to form the hydrated aluminum salt solution 22.

The reaction 18 can be performed in high-temperature stable and acid resistant reaction vessel, such as a tank, with ventilation for H₂ gas formed during the reaction (not shown). In an example, the reaction vessel can comprise a high-temperature resistant plastic that will be thermally stable at temperatures of at least 25° C. to about 120° C. An interior of the reaction vessel can comprise a non-contaminating material that can resist the chemical conditions of the reaction 18 without contaminating the process with additional impurities, also referred to herein as a “non-contaminating material,” a “non-contaminating tank” or a “non-contaminating vessel.” In an example, the reaction vessel can hold from about 400 L to about 4000 L.

Examples of potential reaction vessel materials include, but are not limited to, are polyvinylidene difluoride (PVDF), such as PVDF sold under the trade name KYNAR; polytetrafluoroethylene (PTFE), such as PTFE sold under the trade name TEFLON; fluorinated ethylene propylene (FEP), such as FEP sold under the trade name TEFLON FEP; perfluoroalkoxy alkane (PFA), such as PFA sold under the trade name TEFLON PFA; polypropolyene (PP); or other high temperature plastics that can resist the temperature and chemical attack. The reaction vessel can also comprise a non-chemical resistant base material having a fluorinated coatings, such as a PTFE coating or a PFA coating, or both, an acid-resistant epoxy coating, or a high-temperature plastic coating, such as one of the materials described above.

The reaction vessel can be insulated on some or all sides, including a top and a bottom. The reaction vessel can include a lid that vents to a scrubber or an exhaust. Exhaust fumes from the reaction 18 can go to one or any combination of a scrubber, a condenser, or other device for recycling of the water and acid. The exhaust fumes can be refluxed and condensed acid can be flowed back into the reaction vessel. The reaction vessel can be vented with air to dilute hydrogen level below a lower explosion limit. The vented air can be filtered to remove dust.

The reaction 18 can be limited by the amount of the one or more acids 20 added to the reaction vessel. The one or more acids 20 can be added all at once, metered into the reaction vessel over time, or added at the beginning of the reaction 18 and then further metered in over time. In an example, the aluminum feedstock 12 or the washed aluminum 16 and the water 24 can be added to the reaction vessel, and the one or more acids 20 are metered into the reaction vessel over time at a controlled rate. Additional water 24 can also be metered into the reaction vessel as the one or more acids 20 are metered into the reaction vessel.

At least a stoichiometric amount of the aluminum 12, 16 can be added to the reaction vessel for the reaction 18, but excess aluminum 12, 16 can also be added to the reaction vessel. Excess, unreacted aluminum 12, 16 can be left in the reaction vessel for a subsequent next batch, or the excess, unreacted aluminum 12, 16 can be separated from the hydrated aluminum salt solution 22. In an example, a constant or substantially constant surface area of the aluminum 12, 16 can be used in the reaction vessel from batch to batch, so that aluminum can be added after each batch to replace the aluminum that was reacted in a previous batch. The water 24 and the aluminum 12, 16 can be added to the reaction vessel first followed by metering the one or more acids 20 into the reaction vessel.

The liquid in the reaction vessel can be heated to a temperature of from about 25° C. to about 130° C., such as from about 65° C. to about 110° C. The vessel can be heated using external heat and/or the heat from the exothermic reaction in the vessel. Depending on the composition of the one or more acids 20, e.g., the concentration of the acid in the reactant solution, which can be dictated by the rate of addition of the one or more acids 20 to the reaction vessel, the amount of water 24 in the reaction vessel, and the surface area of the aluminum 12 or 16, the exothermic nature of the reaction between the aluminum 12 or 16 and the acid 20 can provide some or all of the heat necessary for the reaction 18. In some examples, an additional heat source can be used. The vessel can be heated using a heat exchanger in the tank, coated heating elements, or hot fluid pumped through coils or a heat exchanger resistant to the temperature at which the reaction 18 is run and the chemicals present in the reaction vessel.

The liquid in the reaction vessel can be mixed during the reaction 18, for example by rotary stirring of the contents of the reaction vessel, pumping the liquid around the reaction vessel, or another method.

When the reaction 18 occurs with some grades of aluminum, small particles can be seen in the liquid that includes the hydrated aluminum salt solution 22. These small particles can typically be impurities that have not dissolved in the acid mixture. For example, if iron impurities are present in the aluminum feedstock 12 and HCl is used as the acid 20, small black particles can form in the reaction liquid. The lower the purity of aluminum feedstock 12, the more likely that these small particles will be seen in the reaction vessel. Some of the particles will dissolve over time, reducing the purity of the hydrated aluminum salt solution 22, and thus reducing the final purity of the aluminum oxide. Therefore, the hydrated aluminum salt solution 22 can optionally be filtered to remove the impurity particles from the liquid to form a filtered hydrated aluminum salt solution 22. The filtration can take place in conjunction with the reaction 18 or downstream of the reaction 18. In an example, the liquid can be continuously filtered while the reaction 18 is progressing to remove the impurity particles. In an example, at least one of magnetic separation, acid resistant filters, an ion-exchange resin, one or more centrifuges, one or more filter bags, one or more filter cartridges, and settling can be used to accomplish filtration of the hydrated aluminum salt solution 22. Alternative to filtering, or in addition to filtering, the impurity particles can be removed with one or more solvents that can dissolve the particles, but that are not miscible in water so that the solvent with dissolved impurity can be easily removed from the reaction liquid, which is water-based. In examples where the reactant aluminum 12, 16 has sufficiently high purity, these small particles do not appear and thus, in some examples, filtering is not necessary. In some examples, the aluminum feedstock 12 can be of sufficiently high purity such that filtering or removal of impurity particles the hydrated aluminum salt solution 22 is not necessary to achieve acceptable final purity of the aluminum oxide.

In an example, the hydrated aluminum salt solution 22 has less than 3 ppmw total impurities, such as less than 0.5 ppmw of Fe, Na, and Si and less than 0.3 ppmw of all other elements. In other words, other than water, acid, sulfur, carbon, and the hydrated aluminum salt molecules (e.g., PAC), the hydrated aluminum salt solution 22 has only 3 ppmw or less of other impurities.

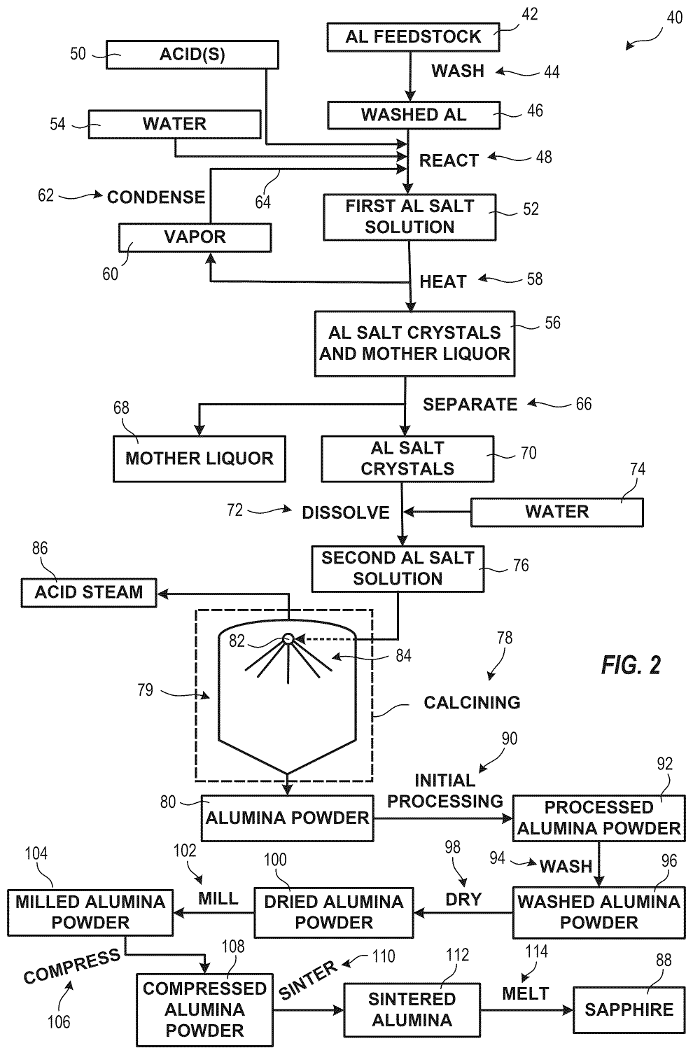

As described in more detail below with respect to FIG. 2, the hydrated aluminum salt solution 22 can be further purified before calcination, such as by precipitation of aluminum salt crystals out of the hydrated aluminum salt solution 22, which can be washed or otherwise purified and redissolved to form a more pure solution. Those having skill in the art will appreciate that there may be other methods of purifying the hydrated aluminum salt solution 22 before performing the spray-roasting calcination described below.

Next, the process 10 can include, at step 26, calcining the one or more hydrated aluminum salt compounds in the solution 22 to convert them to aluminum oxide (also referred to as “alumina”). As shown in FIG. 1, in an example, the hydrated aluminum salt solution 22 is calcined by spraying the hydrated aluminum salt solution 22 into a calcination furnace 28 that is heated to a sufficiently high temperature to convert the one or more hydrated aluminum salt compounds to an alumina powder 30. For simplicity, the step of calcining 26 by spraying the hydrated aluminum salt solution 22 into the furnace 28 will also be referred to as “spray roasting 26” the hydrated aluminum salt solution 22.

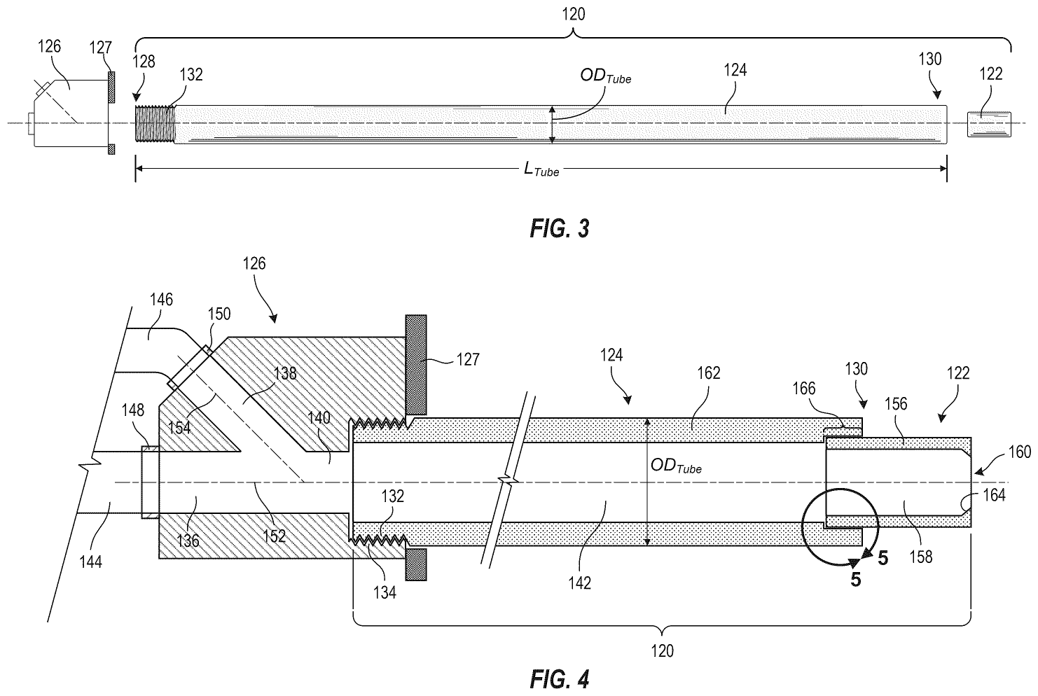

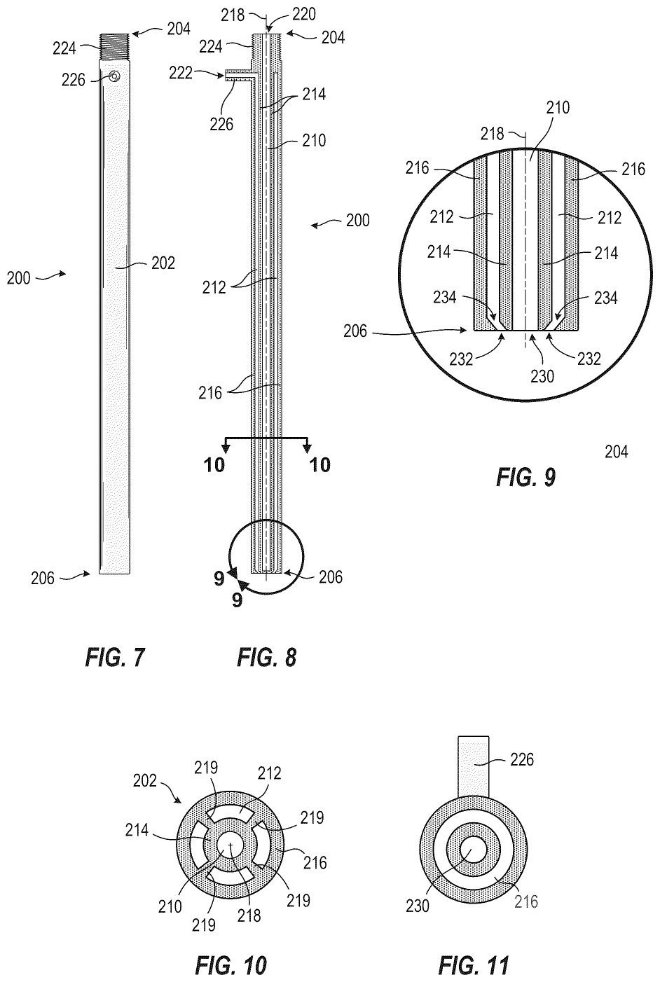

In an example, the hydrated aluminum salt solution 22 is sprayed in a fine atomized mist 32 (shown conceptually in FIG. 1). The mist 32 can be sprayed at a top portion of the calcination furnace 28. In an example, the hydrated aluminum salt solution 22 is sprayed substantially continuously into the calcination furnace 28. In an example, the hydrated aluminum salt solution 22 is sprayed directly into the flame of the calcination furnace 28. The hydrated aluminum salt solution 22 can be sprayed through a spray nozzle 34, such as an alumina atomizing spray nozzle. The hydrated aluminum salt solution 22 can be injected through the spray nozzle 34 using pressurized air. A venturi can be used to suck the hydrated aluminum salt solution 22 into the spray nozzle 34 or air pressure can be used to push the hydrated aluminum salt solution 22 into the spray nozzle 34. In an example, the hydrated aluminum salt solution 22 can be diluted with high-purity water before spray roasting to change the viscosity of the solution and to alter the alumina particle size produced by the spray roasting 26. Further description of various structural details that the spray nozzle 34 can include are described below with respect to FIG. 3-11.

When the hydrated aluminum salt solution 22 is sprayed into the calcination furnace 28, heat energy in the calcination furnace 28 vaporizes the solvent of the hydrated aluminum salt solution 22, e.g., acid, such as HCl, and water, which results in an acid steam 36 that exits the calcination furnace 28. The heat energy also converts the remaining one or more hydrated aluminum salt compounds from the hydrated aluminum salt solution 22, such as PAC, to alumina to form the alumina powder 30. The acid steam 36 can be collected in a heat exchanger, e.g., to condense the acid steam 36, and the condensed acid steam can be recycled back into the process, for example by recycling the condensed acid steam back to the first reaction 18 such as by feeding the condensed acid steam into the first reaction vessel. The acid steam 36 can be collected in a series of at least one of one or more heat exchangers, one or more falling film absorbers, and one or more scrubbers. The heat exchangers or falling film absorbers, or both, can be made of graphite or tantalum. A scrubber can be made of one or more of Kynar, PP, and PE, depending on the temperature of the acid steam 36. The acid steam 36 can be connected to a venturi or cyclone to remove fine alumina dust from the acid steam 36 and to reduce the temperature of the acid steam 36. In an example, the acid steam 36 can be removed tangential to a round furnace 28, which can cause the hot gases in the calcination furnace 28 to swirl in the calcination furnace 28.

In an example, the calcination furnace 28 comprises a cylinder shape with a conical bottom, as shown in FIG. 1. The calcination furnace 28 can be lined with a high-temperature resistant refractory, such as a high-purity alumina refractory. For example, the calcination furnace 28 can be made of high-purity alumina brick with high purity alumina mortar or dry-stacked high purity alumina brick. In accordance with a specific embodiment, an inside surface of the calcination furnace 28 is made of alumina that is 99.2%, or greater, purity aluminum oxide refractory, in order to minimize or eliminate contamination of the resulting alumina powder 50. In more specific embodiments, the refractory of the calcination furnace 28 comprises alumina that is 99.2% purity or purer, or that is 99.6% purity or purer, or that is 99.8% purity or purer.

After being sprayed, such as through the spray nozzle 32, the hydrated aluminum salt solution 22 is heated to a temperature that is sufficiently high to drive off the liquid of the hydrated aluminum salt solution 22 (e.g., water and acid) and to calcine the hydrated aluminum salt from the solution 22 to alumina to form the alumina powder 30. For example, if a PAC solution is sprayed into the calcination furnace 28, the mist 32 of the PAC solution can be heated to a temperature of at least 450° C., such as to a temperature of from about 450° C. to about 1300° C., in order to convert the PAC to alumina. The temperature to which the hydrated aluminum salt solution mist 32 is heated can depend on the phase of alumina that is desired for the particular process. For example, if it is desired to provide predominantly alpha alumina, then the hydrated aluminum salt solution 22 can be heated to a temperature of at least 900° C., or of at least 1000° C., such as from about 900° C. to about 1300° C. or from about 1000° C. to about 1300° C. If lower temperatures are used, e.g., temperatures below about 900° C. or about 1000° C., then the resulting alumina powder 30 can be a mixture of phases with a majority of the mixture being non-alpha phase, generally referred to as gamma alumina. The predominant phase of the alumina powder 30 can be gamma, theta, kappa or other phases of alumina other than alpha alumina depending on the calcination temperature within the calcination furnace 28.

It has been found that the temperatures required to achieve a particular alumina phase, such as alpha alumina, is lower when using the spray roasting calcination furnace 28 described herein as compared to conventional temperatures required to convert hydrated alumina salt crystals, such as PAC crystals, which are not being spray roasted. For example, it has been found that a temperature of at least 1150° C., and in some cases as much as 1600° C. can be required for calcinating larger PAC crystals to alpha alumina. The lower required temperature in the spray roasting calcination furnace 28 can result in substantially lower energy costs for forming the alumina powder 30.

The calcination furnace 28 can be heated by combustion of fuel, such as natural gas, oil or propane, with one or more burners. The burners for heating the calcination furnace 28 can be proximate to the bottom of the calcination furnace 28, for example just above the start of the bottom conical section. One or more of the burners can be tangential to a round circumference of the calcination furnace 28 so that the hot flue gases will swirl in the calcination furnace 28. There can be a temperature gradient in the calcination furnace 28, such as from the burner to the exhaust point 38. The air for the one or more combustion burners can be filtered. In an example, each of the one or more burners can be fed from about 15% to about 50% excess air. The calcination furnace 28 can also be heated by indirect heat, such as from a natural gas tube burner.

As seen in FIG. 1, the bottom of the calcination furnace 48 can be conical and can include a bottom hole or tube for removal of the alumina powder 50. The removal tube can be made of alumina. Alternatively, the bottom of the calcination furnace 48 can be flat with extra alumina powder 50 being left in the bottom of the furnace. As the powder 50 flows out of the calcination furnace 48 via gravity, the alumina powder 50 remaining in the furnace 48 may then form a conical shape. The alumina powder 50 can be removed from the furnace through a tube in the bottom of the calcination furnace 48, such as an alumina removal tube. The removal tube can be heated so that the alumina powder 50 reaches a higher calcination temperature. The alumina powder 50 can be removed continuously from the bottom of the calcination furnace 48. The alumina powder 50 can fill up a container as it comes out of the removal tube. Alumina powder 50 removed from the container can be replaced by gravity flow as more alumina powder 50 is produced. The alumina powder 50 can be removed from the furnace 48 continuously or semi continuously, such as with a rotary valve, rabble rake, auger, or vibrating conveyor.

The alumina powder 50 exiting the calcination furnace 48, e.g., through the removal tube, can help to form at least a partial seal at the furnace exit. The seal can allow the calcination furnace 48 to be operated under slightly negative pressure so that the acidic steam 56, e.g., HCl fumes, will not escape through the bottom exit, but rather will exit the calcination furnace 48 through an exhaust 58. The calcination furnace 48 can be put under negative pressure by a blower that pulls air through a scrubber, such as from the exhaust 58. In an example, the alumina powder 50 can be in the form of hollow shells.

In an example, the spray roasting calcination 26 can be done in two different furnaces or stages. The first phase can comprise spray roasting and calcination to gamma phase alumina powder, e.g., in the spray roasting calcination furnace 48 shown in FIG. 1, and a second calcination phase can comprise converting the gamma phase alumina powder to alpha phase alumina powder 50, e.g., in a conventional solids furnace. The gamma phase alumina powder can be washed between the two calcinations, for example with acid, or water, or both. In an example, the gamma phase alumina powder can be washed with one or more of: a rotary drum filter, filter press, or a pan filter, or both. In an example, the powder can be washed first with acid then with water to remove traces of the acid.

For a two-stage calcination, after being calcined to the gamma phase, the gamma phase alumina powder can be placed into a second furnace and further calcinated to a temperature of at least about 1000° C., such as from about 1000° C. to about 1250° C., to convert the gamma phase alumina powder into alpha alumina powder. After washing, the gamma phase alumina powder can be mixed with water and sprayed into the second furnace. The steam and acid coming off the alumina powder in the second furnace can be condensed in a heat exchanger and be reused in the process. The calcination to alpha alumina can also be performed at hotter temperatures, such as from about 1050° C. to about 1600° C., or from about 1250° C. to about 1600° C., to reduce impurities and to increase the loose density of the powder.

The alumina powder 50 can optionally be further processed 32 into one or more different processed alumina forms. As described in more detail with respect to FIG. 2, the processing 32 can include one or more operations, in any desired order, including but not limited to one or more of: milling, crushing, tumbling, washing, drying, pressing, sintering, and melting to provide an alumina product, such as a sapphire product 34.

FIG. 2 is a flow diagram of another example process 40 for producing aluminum oxide, and in particular for producing high-purity aluminum oxide such as synthetic sapphire. The process 40 is very similar to the process 10 shown in FIG. 1, except that it includes additional processing steps that can be included to further purify the hydrated aluminum salt solution before calcination. Specifically, the process 40 of FIG. 2 includes steps of precipitating out the hydrated aluminum salt from an initial solution, separating the salt crystals from the mother liquor, followed by optional washing and redissolving of the aluminum salt crystals to form a second hydrated aluminum salt solution. The process 40 of FIG. 2 also includes some specific examples of operations that can be performed to process the resulting alumina powder into an alumina product, such as sapphire.

The initial steps of the process 40 can be the same or substantially the same as the process 10. For example, the process 40 can be for the conversion of an aluminum feedstock 42 to alumina. The aluminum feedstock 42 can be similar or identical to the aluminum feedstock 12 described above with respect to the process 10. The process 40 can begin at step 44, with optionally washing the aluminum feedstock 42 with a washing medium (such as one or more of water, an acid, a base, a soap or other surfactant, a solvent, or an alcohol), which can be similar or identical to the washing medium described above for the process 10, to provide a washed aluminum 46.

Next, the process 40 can include, at step 48, reacting aluminum (e.g., the aluminum feedstock 42 or the washed aluminum 46) with one or more acids 50 (which can be the similar or identical to the one or more acids 20 described above for the process 10) to provide a first hydrated aluminum salt solution 52. As with the reacting 18 in the process 10, the one concentration of the one or more acids 50 can be modified, such as by diluting by adding water 54. As with the process 10, in examples wherein the acid 50 includes hydrochloric acid (HCl), the hydrated aluminum salt of the first hydrated aluminum salt solution 52 comprises hydrated aluminum chlorohydrate, also referred to as polyaluminum chloride (PAC), e.g., the group of aluminum salts having the general formula AlₙCl₍₃ₙ₋ₘ₎(OH)ₘ. Specific parameters for the reaction 48 in the process 40—such as reaction temperature, structure and materials of the reaction vessel, extent of the reaction, purity of reactants, amount of reactants added, acid concentration in the reaction vessel, and other processing such as mixing or filtering—can be similar or identical to that which is described above for the reaction 18 in the process 10.

After the reaction 48 to form the first hydrated aluminum salt solution 52, the process 40 can include precipitating at least a portion of the hydrated aluminum salt that is dissolved in the first hydrated aluminum salt solution 52 to produce a mixture 56 of precipitated hydrated aluminum salt crystals and a mother liquor. In an example, precipitation of solid hydrated aluminum salt crystals is accomplished by heating 58 the first hydrated aluminum salt solution 52, which can evaporate water and/or other liquids. Removal of water, gases, and/or other liquids from the first hydrated aluminum salt solution 52 causes the concentration of the hydrated aluminum salt dissolved in the solution 52 to increase so that the first hydrated aluminum salt solution 52 may eventually become saturated causing solid hydrated aluminum salt crystals to precipitate out. In an example, the first hydrated aluminum salt solution 52 can be heated at a temperature of from about 100° C. to about 140° C. Some acids 50 can require a higher temperature during the heating 58 in order to evaporate a sufficient amount of water from the solution 52. In an example, the first hydrated aluminum salt solution 52 can be heated from about 8 hours to about 72 hours. The first hydrated aluminum salt solution 52 can be heated until from about 70% to about 99.9% of the liquid from the first hydrated aluminum salt solution 52 has been evaporated, such as when about 0% to about 20% of the liquid remains. Alternatively, the majority of the liquid can be evaporated and then a small percentage of water, such as high-purity water, can be added to the solid salt to create mother liquor. The first hydrated aluminum salt solution 52 can be heated 58 in the same vessel in which the aluminum 42, 46 was reacted with the one or more acids 50 if any remaining aluminum is removed, or the heating 58 can be performed in a separate vessel.

In an example, the heating 58 to precipitate out the aluminum salt crystals into the mixture 56 of aluminum salt crystals and mother liquor can be performed in a heating vessel comprising materials that will not add contamination to the process, also referred to as a non-contaminating heating vessel or as non-contaminating material. In an example, the heating vessel can comprise at least one of a high-temperature plastic such as PTFE, FEP, PFA, PVDF, alumina; or other high temperature plastics or ceramics that can withstand the temperature of the heating 58 and chemical attack by the salts, liquid, and vapor present in the heating vessel. The heating vessel can also be made of another material that is coated with PTFE, FEP, PFA, PVDF, alumina, or another high-temperature plastic or ceramic that can withstand the temperature and chemicals of the heating vessel.

Examples of methods to heat the first hydrated aluminum salt solution 52 in a heating vessel can include, but are not limited to, at least one of: heating in a furnace, heating with a heat exchanger coil, heating with an immersion heater, heating with a hot oil heater, heating with steam, heating with a PTFE or graphite heat exchanger in the first hydrated aluminum salt solution 52, heating by injecting high-purity steam with a boiler, or heating with external heat. The heating vessel can have a filter air inlet and a vent for the acidic steam. The heating vessel can comprise a draft so that the aluminum salt crystals and mother liquor mixture 56 can be easily removed from the heating vessel.

The heating 58 of the first hydrated aluminum salt solution 52 produces evaporated vapor 60, which in many examples of the process 40 will comprise water vapor and/or acid vapor. In an example, the process 40 can include, at step 62, condensing the vapor 60 in order to recover water and/or acid, such as for recycling back to the reaction 48. A blower can be used to withdraw the vapor 60, which can then be condensed 62 in a heat exchanger to provide a condensed liquid 64. Any uncondensed vapor can be processed by a scrubber, neutralized, and then vented to the atmosphere. The condensed liquid 64 can be recycled and reused in the process, for example by recycling the condensed liquid 64 back to the reaction 48 between the aluminum 42, 46 and the acid 50. The condensed liquid 64 can be purified before recycling. In an example, the condensed liquid 64 can be used to make lower quality alumina.

In an example, the heating 58 to provide the aluminum salt crystals and the mother liquor mixture 56 can be performed in a container or vessel under vacuum, e.g., with the pressure within the heating vessel being less than atmospheric pressure. The application of a vacuum to the heating vessel can increase the rate at which steam and acid vapor 60 are removed from the vessel, which, in turn, can increase the rate and extent of precipitation of aluminum salt crystals into the mixture of the aluminum salt crystals and mother liquor mixture 56. The application of the vacuum to the heating vessel has been found to speed up the rate of evaporation and lower the required reaction temperature.

In an example, the vacuum can be provided with a blower capable of applying a vacuum pressure to the vessel. In an example, a blower rated for at least about 5 inches of water (about 0.012 bar) can be used to provide the vacuum pressure. In an example, the vacuum pressure within the heating vessel (e.g., the pressure below atmospheric pressure) can be at least 0.005 bar vacuum, such as at least about 0.01 bar vacuum, for example at least about 0.015 bar vacuum, such as at least about 0.02 bar vacuum, at least about 0.03 bar vacuum, at least about 0.04 bar vacuum, at least about 0.05 bar vacuum, at least about 0.1 bar vacuum, at least about 0.15 bar vacuum, at least about 0.2 bar vacuum, or at least about 0.25 bar vacuum.

Alternative to, or in conjunction with, the heating 58, HCl gas, high-purity HCl acid solution, or another acid solution, such as H₂SO₄, can be injected into the first hydrated aluminum salt solution 52 in order to lower the solubility of the hydrated aluminum salt dissolved in the first hydrated aluminum salt solution 52 in order to cause the salt to precipitate. In an example, a 38% HCl solution having a high purity can be added to the first hydrated aluminum salt solution 52 in order to precipitate out aluminum salt crystals to provide the solid hydrated aluminum salt crystals and the mother liquor mixture 56.

Next, the process 40 can include, at step 66, separating the mixture 56 crystals to provide separated mother liquor 68 and solid hydrated aluminum salt crystals 70. The separation 66 process can include, but is not limited to, settling, filtering, or centrifuging the hydrated aluminum salt crystals and mother liquor mixture 56. The separation 66 can be performed in one or more non-contaminating separation vessels, which can comprise one of the non-contaminating materials described above with respect to the reaction vessel and the heating vessel. The separation 66 can be done at room temperature or at any temperature up to the evaporation temperature of the process. The hydrated aluminum salt crystals and mother liquor mixture 56 can be allowed to cool to room temperature before separation 66. The hydrated aluminum salt crystals and mother liquor mixture 56 also can be slowly cooled to room temperature before separation 66. In an example, the mother liquor 68 and the hydrated aluminum salt crystals 70 can be separated 66 by draining the mother liquor 68 from a vessel, such as by opening a filtered valve, e.g., a valve with a plastic filter cloth or perforated plastic drain, and removing the mother liquor 68 by gravity drainage from the vessel.

In an example, the separation vessel can comprise a container, such as a high-temperature, acid-resistant plastic container, comprising an acid-resistant filter, such as a filter cloth, a plastic filter, a filter bag, or a plurality of holes in the container, such as in the bottom and sides of the container, that can allow the mother liquor 68 to drain out of the container and away from the hydrated aluminum salt crystals 70. Alternatively, the separation 66 of the mother liquor 68 and the hydrated aluminum salt crystals 70 can be accomplished using one or more of: centrifugation, filtering (such as the drainage filter described above or a filter press-type device), vacuum assisted drainage, or other mechanical separation methods. The separated mother liquor 68 can be used to make a lower purity alumina, as is known in the art.

In an example, after the separation 66, the separated hydrated aluminum salt crystals 70 can optionally be washed with a washing medium (not shown in FIG. 2). In an example, the washing medium can comprise at least one of a high-purity acid (such as HCl), high-purity acetone or another solvent, a high-purity solution of the hydrated aluminum salt (e.g., if the crystals 70 are polyaluminum chloride crystals, then a polyaluminum chloride solution can be used as the washing medium), and high-purity water. In an example, an acid washing liquid (e.g., high-purity HCl) is used with a concentration that is sufficiently high so that a substantial portion of the hydrated aluminum salt crystals 70 do not dissolve back into solution. The washing of the hydrated aluminum salt crystals 70 can also be sufficiently rapid so that a substantial portion of the hydrated aluminum salt crystals 70 do not dissolve. The washing medium can be purified and reused in the process. The hydrated aluminum salt crystals 70 can optionally be milled, ground, or tumbled so that the crystals 36 can have a smaller and/or more uniform size for later in the process 40.

Next, after separating the hydrated aluminum salt crystals 70 from the mother liquor 68 (and after any optional washing of the hydrated aluminum salt crystals 70), the process 40 can include, at step 72, dissolving the hydrated aluminum salt crystals 70 in a solvent, such as water 74, to form a second hydrated aluminum salt solution 76. In an example, the water 74 comprises high-purity water 74 so that the resulting second hydrated aluminum salt solution 76 will also be high-purity, e.g., with less than a specified amount of one or more impurities (as defined and discussed above). If the acid 50 used during the reacting 48 is HCl such that the first hydrated aluminum salt solution 52 comprises a PAC solution, then the second hydrated aluminum salt solution 76 will also comprise PAC dissolved in the water 74. In an example, the dissolving 72 of the separated hydrated aluminum salt crystals 70 to form the second hydrated aluminum salt solution 76 can include heating the water 74 to a specified temperature to increase the dissolution rate of the hydrated aluminum salt crystals 70.

After dissolving the hydrated aluminum salt crystals 70 to form the second hydrated aluminum salt solution 76, the process 40 can include, at step 78, calcining the one or more hydrated aluminum salt compounds in the second hydrated aluminum salt solution 76 to convert them to alumina. As shown in FIG. 2, the calcining 78 of the one or more hydrated salt compounds can comprise spray roasting the second hydrated aluminum salt solution 76, similar to the spray roasting of the hydrated aluminum salt solution 22 in the process 10 of FIG. 1. The spray roasting calcining 78 can be similar or identical to the spray roasting 26 described above with respect to the process 10. For example, the spray roasting 78 can comprise spraying the second hydrated aluminum salt solution 76 into a calcination furnace 79 that is heated to a sufficiently high temperature to convert the one or more hydrated aluminum salt compounds to an alumina powder 80. The calcination furnace 79 can include a spray nozzle 82 configured to disperse the second hydrated aluminum salt solution 76 as a fine mist 84 into the interior of the calcination furnace 79, such as directly into the flame of the calcination furnace 79.

Heat energy in the calcination furnace 79 vaporizes the solvent of the second hydrated aluminum salt solution 76, e.g., acid, such as HCl, and water, which results in an acid steam 86 that exits the calcination furnace 79. The heat energy also converts the remaining one or more hydrated aluminum salt compounds from the second hydrated aluminum salt solution 76, such as PAC, to alumina to form the alumina powder 80. The acid steam 86 can be collected and used in another part of the process 40 e.g., the acid steam 86 can be condensed in a heat exchanger to form an acid solution that can be used to form part of the acid used for one or more steps of the process 40.

The calcination furnace 79 and the spray nozzle 82 used in the process 40 can be similar or identical to the calcination furnace 28 and the spray nozzle 34 described above with respect to the process 10. As noted above, further description of various structural details that the spray nozzle 82 can include are described below with respect to FIG. 3-11.

Specific parameters for the spray roasting 78 of the second hydrated aluminum salt solution 76 in the process 40—such as the calcination temperature, heating source of the calcination furnace 79, structure and materials of the calcination furnace 79 and the spray nozzle 82, etc.—can be similar or identical to that which is described above for the spray roasting 26 in the process 10.

Like the process 10, the alumina powder 80 that results after the spray roasting 78 can be further processed to form a processed alumina, such as a sapphire product 88. While the process 10 does not specifically describe the processing 32 that is performed to form its sapphire 34, the process 40 shows several non-limiting example operation steps that are common in the artificial sapphire product industry.

In an example, the processing of the alumina powder 80 in the process 40 includes, at step 90, performing an initial processing of the alumina powder 80, such as by milling, crushing, or tumbling, to provide a processed alumina powder 92 having a desired size profile. For example, the alumina powder 80 can be wet or dry tumbled to break up lumps, such as by adding the alumina powder 80 to a rotating impeller, with or without water, to break up the lumps. In an example, the processed alumina powder 92 can have an average powder grain size of about 50 nanometers (nm) for gamma alumina and from about 500 nm to about 1000 nm for alpha alumina. In an example, the surface area of the processed alumina powder 92, as determined by Brunauer-Emmett-Teller (BET) theory, is from about 6 square meters per gram (m2/g) to about 15 m2/g. In an example, the processed alumina powder 92 can have a density of at least about 0.2 grams per milliliter (g/mL), such as at least about 0.5 g/mL, for example at least about 1 g/mL.

In an example, the initial processing 90 can also include separating impurities from the alumina powder 80, such as by using a magnet to remove impurities from the alumina powder 80, sieving the alumina powder 80 to remove the impurities, or running the alumina powder 80 through a fluid bed reactor to separate out particles and impurities. All further processing steps described below can be performed on either the alumina powder 80 directly after the spray roasting 78 as the starting material and/or on the processed alumina powder 92 (also referred to as “the alumina powder 80, 92”) as the starting material.

Next, processing of the alumina powder 80, 92 can include, at step 94, washing the alumina powder 80, 92 to provide a washed alumina powder 96, such as by applying a washing medium to the alumina powder 80, 92. In an example, the washing medium that is used for the washing 94 of the alumina powder 80, 92 is water (H₂O), an acid, or a combination thereof, such as a weak HCl acid solution. In some examples, the washing 94 of the alumina powder 80, 92 includes using a first washing medium, such as an acid, to wash the alumina powder 80, 92, followed by washing with a second medium, such as water, one or more times to remove traces of the first washing medium. In an example, the washing medium used during the washing 94 of the alumina powder 80, 92 has a high purity, such as high-purity water or high-purity acid. In an example, washing 64 of the alumina powder 80, 92 can be repeated multiple times, as desired, to remove any residue from the washed alumina powder 96. Washing 64 of the alumina powder 80, 92 can include washing the alumina powder 80, 92 with a weak acid, e.g., an acid that is from about 0.5 wt. % to about 5 wt. % HCl, followed by one or more steps of washing with water to provide the washed alumina powder 96. The alumina powder 80, 92 can be rinsed with other types of acid or just with water instead of the HCl and water. The washed alumina powder 96 can be separated from the one or more washing media by settling or mechanical separation, such as a centrifuge or vacuum filtration (e.g., a rotary drum filter, filter press, a disk filter, or rotary pan filter).

Next, at step 98, the process 40 can include drying the washed alumina powder 96 to provide a dried alumina powder 100. In an example, the drying 98 of the washed alumina powder 96 in a furnace to remove excess water from the washed alumina powder 96 to provide the dried alumina powder 100 before further processing steps, described below. In an example, the washed alumina powder 96 is dried in one or more trays comprising one or more of PTFE, PFA, PVDF, aluminum oxide, or aluminum. In an example, a vacuum furnace, a convection oven, a spray dryer, a flash dryer or a microwave oven can be used to dry the washed alumina powder 96 and to help remove impurities from the washed alumina powder 96.

The process 40 can also include, at step 102, milling, tumbling, or grinding (referred to simply as “the milling 102” for brevity) of one or more of the alumina powder 80, the processed alumina powder 92, or the dried alumina powder 100 (also referred to as the alumina powder 80, 92, 100) to provide a milled alumina powder 104. The milling 102 of the alumina powder 80, 92, 100 reduces the average particle size of the alumina powder 80, 92, 100, so that the milled alumina powder 104 has a reduced average particle size of from about 0.3 micron to about 3 micron. Examples of equipment that can be used for the milling 102 of the alumina powder 80, 92, 100 includes, but is not limited to, a jet mill, an attrition mill, a ball mill, or another type of milling equipment. In some examples, the milling 102 can include vibratory tumbling or tumbling in a barrel can be performed in addition to or in place of conventional milling with one of these milling devices. Barrel tumbling and/or vibratory tumbling can break up lumps of the alumina powder 80, 92, 100 and/or can reduce the size of some of the particles of the alumina powder 80, 92, 100. In some examples, tumbling media can be used, such as high-purity alumina or sapphire tumbling media, to enable or enhance the tumbling and/or milling.

In an example, after the milling 100, the milled alumina powder 104 can be sintered in a vacuum furnace to remove impurities from the milled alumina powder 104 and increase the loose pack density of the powder 74. The furnace temperature and vacuum can be varied to get specified results. In an example, a 0.07 Torr vacuum can be applied to a furnace heated to 450° C. to perform the vacuum sintering of the milled alumina powder 104. In general, higher temperatures and stronger vacuum improve removal of impurities from the milled alumina powder 104.

In an example, any one or more of the alumina powders described above—e.g., the alumina powder 80 directly after the spray roasting 78, the processed alumina powder 92, the washed alumina powder 96, the dried alumina powder 100, and the milled alumina powder 104 (collectively referred to as “the alumina powder 80, 92, 100, 104”) has a alumina purity of at least about 99.99% (abut 4N) alumina purity, such as at least about 99.997% alumina purity, such as at least about 99.999% (about 5N) alumina purity. In an example, any one or more of the alumina powders 80, 92, 100, 104 include impurities of less than 10 parts per million weight (ppmw) in all elements. In an example, any one or more of the alumina powders 80, 92, 100, 104 comprises less than about 30 ppmw total metallic and alkyl impurities, for example less than about 5 ppmw total metallic and alkyl impurities. In an example, any one or more of the alumina powders 80, 92, 100, 104 has a sodium (Na) content of less than 10 ppmw, such as less than about 5 ppmw Na, such as less than about 1 ppmw Na. In an example, any one or more of the alumina powders 80, 92, 100, 104 has an iron (Fe) content of less than 5 ppmw, such as less than about 3 ppmw Fe, such as less than about 1 ppmw Fe. In an example, any one or more of the alumina powders 80, 92, 100, 104 has a silicon (Si) content of less than 10 ppmw, such as less than about 5 ppmw Si, such as less than about 2 ppmw Si. In an example, any one or more of the alumina powders 80, 92, 100, 104 has a titanium (Ti) content of less than 1 ppmw, such as less than about 0.2 ppmw Ti. In an example, any one or more of the alumina powders 80, 92, 100, 104 has a magnesium (Mg) content of less than about 5 ppmw, such as less than about 2 ppmw Mg. In an example, any one or more of the alumina powders 80, 92, 100, 104 has a calcium (Ca) content of less than 5 ppmw, such as less than about 2 ppmw Ca. In an example, any one or more of the alumina powders 80, 92, 100, 104 has a potassium (K) content of less than about 5 ppmw. In an example, any one or more of the alumina powders 80, 92, 100, 104 has a copper (Cu) content of less than about 1 ppmw. In an example, any one or more of the alumina powders 80, 92, 100, 104 has a chromium (Cr) content of less than about 1 ppmw In an example, any one or more of the alumina powders 80, 92, 100, 104 comprises less than 5 ppmw combined for Fe, Na, and Si. In an example, any one or more of the alumina powders 80, 92, 100, 104 has less than 5 ppmw combined for Fe, Na, and Si, and 3 ppmw total for all other elements. In an example, any one or more of the alumina powders 80, 92, 100, 104 has less than 3 ppmw combined for Fe, Na, and Si and less than 1 ppmw total for all other elements.

The process 40 can also include, at step 106, compressing any one or more of the alumina powders 80, 92, 100, 104 into a compressed alumina powder 108 that has a higher density than the alumina powder 80, 92, 100, 104 before the compressing 106. The compressed alumina powder 108 can be in the form of any pressed shape, such as compressed pucks, pellets, or granules, and in particular for any shape that is conducive to eventual conversion into sapphire ingots. Examples of pressing methods that can used for the compressing 106 of the alumina powder 80, 92, 100, 104 include, but are not limited to, uniaxial pressing, hydraulic pressing, cold isostatic pressing (CIP), or hot isostatic pressing (HIP). In an example, the density of the alumina powder 80, 92, 100, 104 before the compressing 106 can be from about 0.3 grams per cubic centimeter (g/cm³) to about 1.0 g/cm³, and the compressed alumina powder 108 after the compressing 106 can have a density of at least about 1.7 g/cm³, such as at least about 1.8 g/cm³, at least about 1.9 g/cm³, at least about 2 g/cm³, at least about 2.1 g/cm³, at least about 2.2 g/cm³, at least about 2.3 g/cm³, at least about 2.4 g/cm³, or at least about 2.5 g/cm³, such as from about 1.7 g/cm³ to about 2.3 g/cm³. In example, a binder can be added to the alumina powder 80, 92, 100, 104 before or during the compressing 106 so that the resulting compressed alumina powder 108 is bound together with the binder. Examples of binders that can be added to bind the compressed alumina powder 108 include, but are not limited to, water, polyethylene glycol (PEG), and polyvinyl alcohol (PVA). The compressing of the alumina powder 80, 92, 100, 104 can include forming the resulting compressed alumina powder 108 into a specified shape including, but not limited to, a cylinder, a puck, a rectangular prism, and a hexagonal prism. In an example, the shape of the compressed alumina powder 108 is chosen for packing efficiency of the compressed alumina powder 108 in a crucible for sintering (described below).

Next, the process 40 can include, at step 110, sintering the compressed alumina powder 108 to provide a sintered alumina 112. The sintering 110 further increases the density of the alumina. For example, the compressed alumina powder 108 can have a density of from about 1.7 g/cm³ to about 2.3 g/cm³ and the sintering 110 of the compressed alumina powder 108 can result in the sintered alumina 112 having a density of at least about 3.0 g/cm³, such as at least about 3.1 g/cm³, at least about 3.2 g/cm³, at least about 3.3 g/cm³, at least about 3.4 g/cm³, at least about 3.5 g/cm³, at least about 3.6 g/cm³, at least about 3.7 g/cm³, at least about 3.8 g/cm³, at least about 3.9 g/cm³, or at least about 4 g/cm³, such as from about 3.2 g/cm³ to about 3.9 g/cm³. In an example, the sintering 110 comprises exposing the compressed alumina powder 108 to a temperature of from about 1500° C. to about 2050° C., such as from about 1550° C. to about 1600° C. In some examples, the sintering 110 includes applying a vacuum to the compressed alumina powder 108 (e.g., generating a vacuum in the crucible in which the sintering 110 is performed). In an example, the atmosphere that the compressed alumina powder 108 is exposed to during the sintering 110 can comprise, for example, one or more of air, hydrogen (H₂) gas, carbon dioxide (CO₂) gas, an inert gas (such as nitrogen (N₂) or argon (Ar)). The sintering 110 of the compressed alumina powder 108 can be performed in a furnace that is heated, for example, with electric resistance with elements made of silicon carbide (SiC), graphite, tungsten, or molybdenum disilicide (MoSi₂), or with natural gas burners. In an example, the sintering furnace can be insulated with aluminum oxide fiber board or bubble alumina. It has been surprisingly found that when the sintering 110 of the compressed alumina powder 108 is included in the process 40, the resulting sintered alumina 112 can have substantially reduced impurities compared to the unsintered alumina, such as the compressed alumina powder 108, or one of the alumina powders 80, 92, 96, 100, 104 before one or more of the other processing steps 90, 94, 98, 102 described above.

The sintered alumina 112 (or earlier processed alumina, such as the alumina powder 80 directly after the spray roasting 78, the washed alumina powder 96, the dried alumina powder 100, the milled alumina powder 104, or the compressed alumina powder 108 (collectively referred to as “the alumina powder 80, 92, 100, 104, 108”) can be used as a feedstock for sapphire ingot growth. Therefore, in an example, the process 40 includes, at step 114, melting the alumina powder 80, 92, 100, 104, 108 and/or the sintered alumina 112 to convert the alumina into sapphire crackle, e.g., via the Verneuil process, to provide the sapphire 88. In an example, the resulting sapphire 88 can be used, for example, as for the cover glass for mobile electronic devices.

### Spray Nozzle for Spray Roasting Applications

FIG. 3-11 show examples of spray nozzles that the inventors have developed to address the challenges associated with exposure of the spray nozzle to corrosive and high-temperature conditions, including, but not necessarily limited to, for use as the spray nozzle 34 or 82 during the spray roasting 26, 78 in the processes 10, 40. FIG. 3-5 show a first example of a spray nozzle 120 comprising multiple components that can be assembled together to form the spray nozzle 120. FIG. 6-11 shown a second example of a spray nozzle 200 comprising a single-piece construction.

The spray roasting 26, 78 described above with respect to processes 10 and 40 above for which the spray nozzles 120 and 200 can be used involve spraying a solution into a corrosive atmosphere. For example, the solution that is being sprayed by the nozzle 120, 200 can have a pH of about 4 or less, such as about 3.9 or less, about 3.85 or less, about 3.8 or less, about 3.75 or less, about 3.7 or less, about 3.65 or less, about 3.6 or less, about 3.55 or less, about 3.5 or less, about 3.45 or less, about 3.4 or less, about 3.35 or less, about 3.3 or less, about 3.25 or less, about 3.2 or less, about 3.15 or less, about 3.1 or less, about 3.05 or less, about 3 or less, about 2.95 or less, about 2.9 or less, about 2.85 or less, about 2.8 or less, about 2.75 or less, about 2.7 or less, about 2.65 or less, about 2.6 or less, about 2.55 or less, about 2.5 or less, about 2.45 or less, about 2.4 or less, about 2.35 or less, about 2.3 or less, about 2.25 or less, about 2.2 or less, about 2.15 or less, about 2.1 or less, about 2.05 or less, or a pH of about 2 or less. For example, solutions of hydrated aluminum salts (e.g., PAC)—such as the solutions 22, 76 that are subject to the spray roasting 26, 78 in the processes 10, 40—can themselves have a relatively highly acidic pH of about 3. In addition, the hydrated aluminum salt solution can include some remnant acid such as HCl that was used in the reaction 18, 48 to form one or more hydrated aluminum salt compounds (such as HCL).

When sprayed into a furnace, such as the calcination furnace 28, 79, it can result in a concentrated acidic vapor (e.g., a concentrated hydrochloric acid vapor) in the furnace and within and around the spray nozzle 120, 200. As will be appreciated by those of skill in the art, both the acid (such as HCL) and the hydrated aluminum salt solution (such as PAC) can be quite corrosive

Moreover, this acidic environment is created in a furnace that is heated very high temperatures, e.g., to temperatures of at least 500° C., such as at least 550° C., at least 600° C., at least 650° C., at least 700° C., or at least 750° C., and typically much higher, such as at least 900° C. to as high as 1600° C., depending on the specific hydrated aluminum salt compound being calcined and the phase of alumina desired. Those having skill in the art will appreciate that the acidic vapor and the high temperatures can be damaging or corrosive to the material that form the spray nozzles 120, 200 into which the hydrated aluminum salt solution 22, 76 is sprayed. While there are many materials that are known to avoid corrosion when exposed to HCl or other acid vapor, many of those materials are unable to withstand such high temperatures. Similarly, there are materials that are known to be able to withstand very high temperatures, but many of those materials will corrode when exposed to HCl or other acid vapors.

In some examples, such as for the alumina production processes described above, it can be desirable for the mist that is formed by the spray nozzle 120, 200 have very fine droplets with a uniform or substantially uniform size, e.g., so that the resulting alumina powder 30, 80 after the spray roasting will have a corresponding small particle size. In an example, the spray nozzle 120, 200 can produce mist droplets having an average droplet size of from about 1 micrometer (μm) to about 100 μm, such as from about 5 μm to about 85 μm, for example from about 10 μm to about 75 μm, such as from about 15 μm to about 70 μm, for example from about 20 μm to about 60 μm, such as from about 25 μm to about 50 μm. Creating such a fine mist difficult in general, but it can be particularly challenging for hydrated aluminum salt solutions, which can be particularly viscous or can form a slurry or slurry like solution that is to be sprayed.

Those having skill in the art will also appreciate that there may be many other manufacturing processes other than those for forming high-purity alumina and/or that include spraying other corrosive materials at high temperatures that may have similar material challenges for the spray nozzle used for that spraying. For example, the spray nozzles 120 and 200 can be used to spray solutions other than chloride salt solutions (such as PAC or other hydrated aluminum chloride salt solutions), such as sulfide salt solutions, or nitride salt solutions. The spray nozzles 120 and 200 can also be used to spray slurries or powders for spray drying applications, for heat treating processes, or for calcination processes, rather than a solution such as a salt solution. The spray nozzles 120 and 200 can be used for solutions or slurries comprising compounds other than hydrated aluminum salt compounds, including, but not limited to, aluminum sulfate, aluminum nitrate, and iron (III) chloride. The spray nozzles 120 and 200 can also be used to spray dry powders mixed with a slurry medium, such as water, including, but not limited to, one or more oxide powders and one or more ceramic powders. Examples of such powders include, but are not limited to, aluminum oxide, iron oxide, and copper oxide.

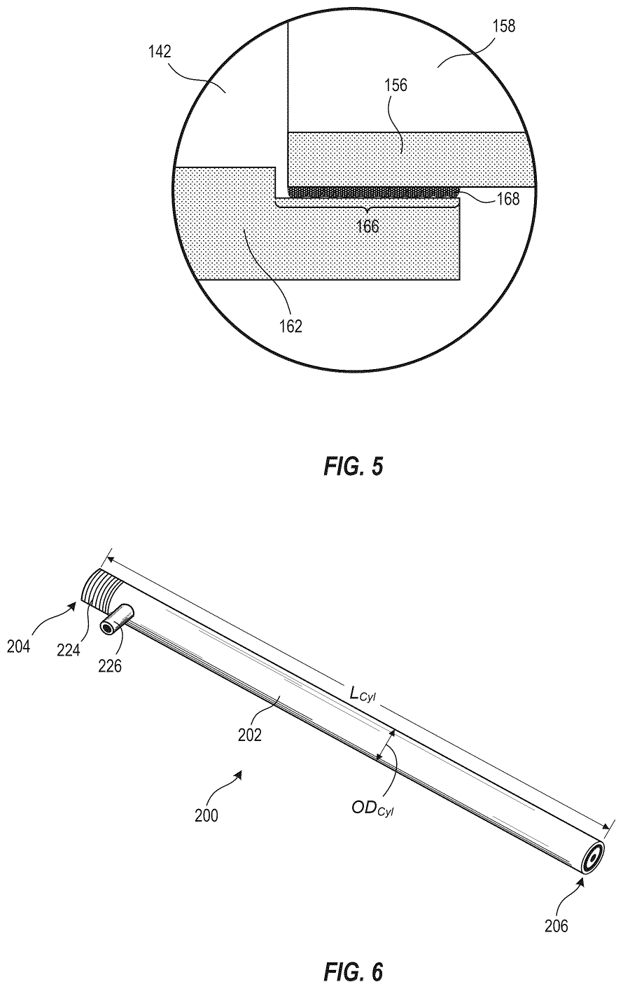

FIG. 3 is an elevation view of the spray nozzle 120 when disassembled into its two primary components: a spray tip 122 and an atomizing tube 124. FIG. 4 is an enlarged cross-sectional view of the spray nozzle 120 when assembled, and FIG. 5 is a close-up cross-sectional view of the coupling between the atomizing tube 124 and the spray tip 122. FIGS. 3 and 4 also show a venturi 126 to which the atomizing tube 124 can be coupled. As described in more detail below, the venturi 126 feeds the liquid or solution being sprayed by the spray nozzle 120 (also referred to as “the spray liquid”), such as one of the hydrated aluminum salt solutions 22, 76 described above, into the atomizing tube 124. Those having skill in the art will appreciate, however, that when the term “spray liquid” is used, it can also refer to a solution or a slurry, as described above. The venturi 126 also mixes a compressed gas into the spray liquid to atomize the spray liquid into a fine mist. In most examples, the compressed gas will be compressed air, such that for the remainder of the description, the gas will be referred to as “air.” Those having skill in the art will appreciate, however, that when the word “air” is used, it could be substituted with another gas or mixture of gasses and still fall within the scope of the present disclosure.

In an example, the atomizing tube 124 comprises an elongated cylinder so that the spray tip 122 and the atomizing tube 124 can be inserted into a heated vessel, such as the calcination furnace 28, 79 described above. Therefore, in an example, one or both of the spray tip 122 and the atomizing tube 124 are made from a material or materials that can withstand high temperatures, such as temperatures of at least 300° C., at least 350° C., at least 400° C., at least 450° C., at least 500° C., at least 550° C., at least 600° C., at least 650° C., at least 700° C., at least 750° C., at least 800° C., at least 850° C., at least 900° C., at least 950° C., at least 1000° C., at least 1150° C., at least 1200° C., at least 1250° C., at least 1300° C., at least 1350° C., at least 1400° C., at least 1450° C., at least 1500° C., at least 1550° C., or even as high as 1600° C. or more. In an example, both the spray tip 122 and the atomizing tube 124 are made from one or more materials that are resistant to corrosion from the corrosive compound or compounds of the spray liquid, such as HCl or other acids that may be reacted with aluminum metal to form the hydrated aluminum salt solutions 22, 76 described above with respect to the processes 10 and 40. In addition, in some examples where the spray nozzle 120 is being used to spray a high-purity material (e.g., a high-purity hydrated aluminum salt solution to form a high-purity alumina powder, as in the processes 10 and 40), one or both of the spray tip 122 and the atomizing tube 124 are made from a material or materials that is non-contaminating to the high-purity solution, slurry, or powder that is being sprayed by the spray nozzle 120, e.g., so that after spraying with the spray nozzle 120, any impurities that are added to the resulting solution or powder is below a specified threshold. As noted above, this is a challenging set of conditions for a material to be able to withstand without melting, charring, burning, or corroding.

In an example, one or both of the spray tip 122 and the atomizing tube 124 are formed from one or more ceramic materials that can withstand the temperatures described above and the one or more corrosive compounds that may be present in the spray liquid. Examples of ceramic materials that can be used to form the spray nozzle 200 include, but are not limited to, silicon nitride (SiN, such as Si₃N₄), graphite (e.g., crystalline or ceramic carbon, for example comprising one or more layers of graphene, either natural or synthetic), silicon carbide (SiC), sintered alumina (Al₂O₃) (which can provide for further temperature resistance when doped with magnesia (MgO) and/or silica (SiO₂), zirconia (ZrO₂), and boron nitride (BN).

In an example, the venturi 126 need not be inserted into or put into contact with the heated vessel into which the spray liquid is being sprayed by the spray nozzle 120. Therefore, the venturi 126 need not be made from a high-temperature withstanding material. But, since the venturi 126 will still be exposed to the one or more corrosive compounds in the spray liquid, it is preferred that the venturi 126 be made from a material that is chemically inert to the one or more corrosive compounds, such as a non-reactive plastic such as PTFE or PVDF. In an example, the material of the venturi 126 will also be non-contaminating to the spray liquid and/or to the compressed air so that impurities will not be added to the spray liquid or that will only be added below a specified threshold. Examples of materials that can be used to make the venturi 126 include, but are not limited to, polyvinylidene difluoride (PVDF), such as PVDF sold under the trade name KYNAR; polytetrafluoroethylene (PTFE), such as PTFE sold under the trade name TEFLON; fluorinated ethylene propylene (FEP), such as FEP sold under the trade name TEFLON FEP; perfluoroalkoxy alkane (PFA), such as PFA sold under the trade name TEFLON PFA; polypropolyene (PP); or polymers that can resist the temperature and chemical attack.

In an example, the venturi 126 can include a heat-resistant plate 127 (shown in FIG. 4) that can be positioned between the venturi 126 and a wall of the high-temperature vessel, such as the calcination furnace 28, 79. The heat-resistant plate 127 ensures that the venturi 126 need not come into direct contact with the wall of the high-temperature vessel so that the high temperature of the vessel wall does not melt or char the venturi 126. An example of a material that can be used to form the heat-resistant plate 127 includes, but is not limited to, a fiber board, or a ceramic such as one of the ceramics described above for the spray tip 122 and the atomizing tube 124. However, since the heat-resistant plate 127 will not be in contact with the spray liquid, the material of the heat-resistant plate 127 need not be non-contaminating and can include impurities that would otherwise contaminate the high-purity spray liquid.

The venturi 126 and the atomizing tube 124 are configured to be coupled together at a proximal end 128 of the atomizing tube 124. The spray tip 122 and the atomizing tube 124 are configured to be coupled together at an opposite distal end 128 of the atomizing tube 124. In an example, a coupling structure between the venturi 126 and the proximal end 128 of the atomizing tube 124, such as threading 132 on the atomizing tube 124 at the proximal end 128 and corresponding mating threading 134 on the venturi 126. In the non-limiting embodiment shown in FIG. 4, the tube threading 132 comprises male threads on an outer surface of the proximal end 128 and the venturi threading 134 comprises mating female threads on an interior surface of a bore within the venturi 126. However, those having skill in the art will appreciate that the orientation of the threading 132, 134 could be reversed with the tube threading 132 being female threads on an interior bore of the atomizing tube 124 and the venturi threading 134 being male threads on an outer surface of some structure of the venturi 126, or other coupling structures or materials could be used, such as one or more fasteners, an adhesive (such as a cement), or welding. A benefit of mating threading 132, 134 is that it provides for a secure connection that is sufficiently sealed for most spraying applications, and in particular for the spray roasting 26, 78 described herein, but that is also easily reversible so that the venturi 126 can be decoupled from the atomizing tube 124 if desired.

The venturi 126 is configured to mix together a compressed air with the spray liquid. The mixing together of a spray liquid and compressed air in a venturi 126 is a commonly used method of generating an atomized or substantially atomized spray of the spray liquid suspended in air. In an example, best seen in the cross-section of FIG. 4, the venturi 126 includes a conduit 136 for receiving the spray liquid (also referred to as “the liquid conduit 136”) and a conduit 138 for receiving compressed air (also referred to as “the air conduit 138”). The air conduit 138 joins together with the liquid conduit 136 within the venturi 126 so that the spray liquid mixes with compressed air within a mixing conduit 140 and within an inner bore 142 of the atomizing tube 124.

The venturi 126 is configured to connect to a first feed line 144 for the spray liquid (also referred to as “the liquid feed line 144”) in order to supply the spray liquid to the liquid conduit 136. Similarly, the venturi 126 is configured to connect to a second feed line 146 for the compressed air (also referred to as “the air feed line 146”) in order to supply compressed air to the air conduit 138. In an example, the venturi 126 includes a corresponding connecting structure for coupling to each feed line 144, 146. For example, the venturi 126 can include a first compression fitting 148 for engaging the liquid feed line 144. For example, if the liquid feed line 144 comprises a flexible tube or other flexible structure then the liquid feed line 144 can be inserted into and sealed with the first compression fitting 148 (also referred to herein as “the liquid compression fitting 148”). The venturi 126 can also include a second compression fitting 150 for engaging the air feed line 146—e.g., if the air feed line 146 comprises a flexible tube or other flexible structure then the air feed line 146 can be inserted into and sealed with the second compression fitting 150 (also referred to herein as “the air compression fitting 150”). In an example, one or both of the feed lines 144, 146 and/or one or both of the compression fittings 148, 150 are formed from a flexible polymer material, such as polypropylene, so that the feed line 144, 146 and/or the compression fitting 148, 150 can seal against the other.

As shown in FIG. 4, in an example, the air conduit 138 has a cross-sectional area that is smaller than that of the liquid conduit 136 and the mixing conduit 140, so that when the compressed air exits the air conduit 138 into the larger mixing conduit 140, it can expand and act to mix and aerate the spray liquid in the mixing conduit 140. In an example, the liquid conduit 136 and the mixing conduit 140 can both have a circular cross section with an inner diameter of about ½ inches (about 12.7 millimeters (mm)) and the air conduit 138 can also have a circular cross section, but with an inner diameter of about ⅜ inches (about 9.5 mm). The inner bore 142 of the atomizing tube 124 can have a cross-sectional area that is slightly larger than that of the mixing conduit 140 so that the compressed air can further expand and disperse the spray liquid as the mixture moves from the smaller mixing conduit 140 to the larger inner bore 142. In an example, the mixing conduit 140 can have a circular cross section with an inner diameter of about ½ inches (about 12.7 mm), as described above, and the inner bore 142 of the atomizing tube 124 can also have a circular cross section, but with an inner diameter of about 0.65 inches (about 16.5 mm).

In an example, shown in FIG. 4, the liquid conduit 136 is coaxial or substantially coaxial with the atomizing tube 124, e.g., so that a central axis 152 of the liquid conduit 136 is also the central axis of the inner bore 142 of the atomizing tube 124. In an example, also shown in FIG. 4, the mixing conduit 140 is coaxial or substantially with the liquid conduit 136 in the venturi 126 and with the inner bore 142 of the atomizing tube 124, i.e., so that the axis of the liquid conduit 136, the mixing conduit 140, and the inner bore 142 are all the same central axis 152, such that when the spray liquid flows from the liquid conduit 136 to the mixing conduit 140 to the inner bore 142, its overall direction of flow is in a straight line. In an example, the air conduit 138 is angled relative to the air conduit 138 and the mixing conduit 140, e.g., so that a central axis 154 of the air conduit 138 is angled relative to the central axis 152 of the liquid conduit 136 and the mixing conduit 140. An angled orientation of the air conduit 138 relative to the liquid conduit 136, at least at the point where the air conduit 138 enters the mixing conduit 140, causes the flow direction of the compressed air as it enters the mixing conduit 140 to be in a different direction than the flow direction of the spray liquid within the liquid conduit 136 and the mixing conduit 140, which can enhance mixing and aeration of the spray liquid within the mixing chamber and the inner bore 142 of the atomizing tube 124.

The spray tip 122 can be included to further dissipate and/or atomize the spray liquid out of the spray nozzle 120 so that a resulting mist of the spray liquid will have a desired droplet size. For example, as described above, for the alumina producing processes 10 and 40 described above including spray roasting 26, 78 in a calcination furnace 28, 79, it can be desirable to have droplet sizes of from about 1 μm to about 100 μm, such as from about 5 μm to about 85 μm, for example from about 10 μm to about 75 μm, such as from about 15 μm to about 70 μm, for example from about 20 μm to about 60 μm, such as from about 25 μm to about 50 μm, so that the spray roasting 26, 78 will result in a fine alumina powder 30, 80 having similar particle sizes. In an example, the spray tip 122 comprises a cylindrical outer wall 156 that surrounds an inner bore 158, which leads to a nozzle outlet opening 160. In an example, the inner bore 158 and the nozzle outlet opening 160 of the spray tip 122 both have an inner diameter that is smaller than the inner diameter of the inner bore 142 of the atomizing tube 124, which is surrounded by a cylindrical outer wall 162 of the atomizing tube 124, as can be seen in FIG. 4. The smaller inner diameter of the inner bore 158 and the nozzle outlet opening 160 of the spray tip 122 compared to that of the inner bore 142 of the atomizing tube 124 can act to further disperse the spray liquid in the compressed air and/or to further reduce the droplet size of the resulting mist. In an example, an optional bevel 164 can be included adjacent to the nozzle outlet opening 160 where the inner bore 158 of the spray tip 122 is tapered so that the inner diameter of the spray tip 122 decreases down from the inner diameter of the inner bore 158 through most of the length of the spray tip 122 to a smaller diameter for the nozzle outlet opening 160.

As mentioned above, the spray tip 122 is coupled to the atomizing tube 124 at the distal end 130. In an example, because the inner bore 158 of the spray tip 122 has a smaller cross-sectional area than the inner bore 142 of the atomizing tube 124, the spray tip 122 can be configured to fit within the atomizing tube 124 at the distal end 130. For example, the inner bore 142 of the atomizing tube 124 can include a widened section 166 that axially extends a specified distance from the distal end 130 with an inner diameter that is slightly larger than an outer diameter of the outer wall 156 of the spray tip 122 so that the spray tip 122 will fit inside the widened bore section 166, as shown in FIG. 4. In the example shown in FIG. 4, the thicknesses of the outer walls 156, 162, and particular of the outer wall 156 of the spray tip 122, are not thick enough to accommodate threading like the example mating threading 132 and 134 that provides for coupling between the proximal end 128 of the atomizing tube 124 and the venturi 126. Therefore, in an example, the spray tip 122 is coupled to the atomizing tube 124 with a high-temperature resistant cement 168, as shown in the close-up view of FIG. 5. The cement 168 can be applied to one or both of an inner surface of the widened bore section 166 of the atomizing tube 124 and an outer surface of the outer wall 156 of the spray tip 122. When the cement 168 sets, the spray tip 122 is securely couple to the atomizing tube 124 at the distal end 130. In an example, the high-temperature resistant cement 168 comprises a ceramic cement material that can adhere to the material of the spray tip 122 and the atomizing tube 124 and that, when set, bonds strongly to both. In an example, the high-temperature resistant cement 168 can withstand the temperatures described above for the materials of the spray tip 122, the atomizing tube 124, and the venturi 126, i.e., at least 450° C. or more, or as high as 900° C. or more, such as 1000° C. or more, 1150° C. or more, 1300° C. or more, 1400° C. or more, 1500° C. or more, or even as high as 1600° C. or more. Although the cement 168 is unlikely to be exposed to the spray liquid and air mixture within the inner bores 142, 158 of the atomizing tube 124 and the spray tip 122, in an example, the material of the cement 168 is also resistant to corrosion under the same conditions as discussed above for the ceramic materials of the spray tip 122, the atomizing tube 124, and the venturi 126. Examples of high-temperature resistant cement materials include, but are not limited to, an alumina based ceramic cement such as the cement sold under the trade name RESBOND 940HT by Cotronics Corp., New York, New York, USA.

In an example, the atomizing tube 124 can have a length L_{Tube} from the proximal end 128 to the distal end 130 (FIG. 3) that is long enough so that the spray nozzle 120 can be inserted entirely through a thick wall of a high-temperature vessel, such as a calcination furnace, so that the nozzle outlet opening 160 of the spray tip 122 is at a desired location within the interior of the high-temperature vessel so that the mist of the spray liquid that is exiting the spray tip 122 will be located at a desired position to achieve a desired effect (e.g., so that the one or more hydrated aluminum salt compounds in the spray liquid are calcined to form alumina powder 80, 92 within the high-temperature vessel. The length L_{Tube} of the atomizing tube 124 can also be selected so that the spray liquid will be sufficiently atomized by the compressed air, e.g., so that the average droplet size of the spray liquid suspended in the compressed air are of a desired size and/or so that the droplets are dispersed within the compressed air to a desired degree (e.g., uniformly or substantially uniformly dispersed in the compressed air) by the time the droplets reach the distal end 130. In an example, the length L_{Tube} of the atomizing tube 124 is from about 500 mm (about 19.7 inches) to about 650 mm (about 25.6 inches), such as from about 525 mm (about 20.7) to about 590 mm (about 23.3 inches), such as from about 550 mm (about 21.6 inches) to about 580 mm (about 22.8 inches), such as about 560 mm (about 22 inches), however the ideal length L_{Tube} may depend on other factors including, but not limited to, the specific spray liquid (e.g., the compound or compounds that are present in the spray liquid), a concentration of the component or components in the spray liquid (when the spray liquid is a solution), the pressure of the compressed air, the flow rates of the spray liquid and the compressed air, and the desired extent of atomization.

In an example, the atomizing tube 124 can have a width in the largest lateral direction, such as an outer diameter OD_{Tube} if the atomizing tube 124 has a circular cross section (see FIGS. 3 and 4), that is small enough to fit within a relatively small opening in the wall of the high-temperature vessel, such as a calcination furnace. In an example, the outer diameter OD_{Tube} or other width in the widest lateral direction of the atomizing tube 124 is from about 6 mm (about ¼ inch) to about 60 mm (about 2½ inch), such as from about 7.5 mm (about 0.3 inch) to about 50 mm (about 2 inch), for example from about 10 mm (about 0.4 inch) to about 40 mm (about 1½ inch), such as from about 12.5 mm (about ½ inch) to about 32 mm (about 1¼ inch), for example from about 15 mm (about 0.6 inch) to about 25 mm (about 1 inch), for example from about 16.5 mm (about 0.65 inch) to about 23 mm (about 0.9 inch), such as about 19 mm (about ¾ inch).

Turning to FIG. 6-11, another embodiment of a spray nozzle 200 can be used to spray any one of the spray liquids described above for the spray nozzle 120 into a high-temperature vessel, such as the calcination furnace 28. 79. The primary difference between the spray nozzle 200 and the spray nozzle 120 is that the spray nozzle 200 comprises a single component that serves the functions of both the spray tip 122 and the atomizing tube 124 for the spray nozzle 120. Therefore, like the atomizing tube 124 and the spray tip 122, the spray nozzle 200 can be configured to be inserted into a high-temperature heated vessel, such as the calcination furnace 28, 79 in the processes 10 and 40. As such, in an example, the single-piece spray nozzle 200 is made from one or more materials that can withstand high temperatures, such as temperatures of at least 300° C., at least 350° C., at least 400° C., at least 450° C., at least 500° C., at least 550° C., at least 600° C., at least 650° C., at least 700° C., at least 750° C., at least 800° C., at least 850° C., at least 900° C., at least 950° C., at least 1000° C., at least 1150° C., at least 1200° C., at least 1250° C., at least 1300° C., at least 1350° C., at least 1400° C., at least 1450° C., at least 1500° C., at least 1550° C., or even as high as 1600° C. or more. In an example, the spray nozzle 120 is made from one or more materials that are resistant to corrosion from the corrosive compound or compounds of the spray liquid, such as HCl or other acids that may be reacted with aluminum metal to form the hydrated aluminum salt solutions 22, 76 described above with respect to the processes 10 and 40. In addition, in some examples where the spray nozzle 200 is being used to spray a high-purity material (e.g., a high-purity hydrated aluminum salt solution to form a high-purity alumina powder, as in the processes 10 and 40), the spray nozzle 200 is made from one or more materials that are non-contaminating to the high-purity solution, slurry, or powder that is being sprayed by the spray nozzle 200, e.g., so that after spraying with the spray nozzle 200, any impurities that are added to the resulting solution or powder is below a specified threshold. As with the spray tip 122 and the atomizing tube 124 of the spray nozzle 120, examples of ceramic materials that can be used to form the spray nozzle 200 include, but are not limited to, silicon nitride (Si₃N₄), sintered alumina (Al₂O₃) (which can provide for further temperature resistance when doped with magnesia (MgO) and/or silica (SiO₂), zirconia (ZrO₂), boron nitride (BN), graphite, and silicon carbide (SiC).

As can be seen in FIG. 6, the spray nozzle 200 comprises an elongated cylinder 202 that includes separate interior channels for receiving the spray liquid (e.g., a liquid, solution, or slurry to be sprayed by the spray nozzle 200) and compressed air, as described in more detail below with respect to FIG. 8-11. The elongated cylinder 202 includes a proximal end 204, which can be connected to one or more supply lines to supply the spray liquid and the compressed air to the spray nozzle 200, and an opposite distal end 206, which can be configured for dispersing an atomized mist of the spray liquid into a high-temperature heated vessel such as a calcination furnace.

As can best be seen in FIG. 8-10, the interior of the elongated cylinder 202 includes a first channel 210 for carrying the spray liquid from at or near the proximal end 204 to the distal end 206 of the elongated cylinder 202 (also referred to as “the liquid channel 210”) and a second channel 212 for carrying the compressed air from at or near the proximal end 204 to the distal end 206 (also referred to as “the air channel 212”). For most of the length of the elongated cylinder 202, the liquid channel 210 and the air channel 212 are separated by an interior wall 214 so that the spray liquid in the liquid channel 210 and the compressed air in the air channel 212 are not combined until at a desired point along the length of the elongated cylinder 202. The elongated cylinder 202 also includes an outer wall 216 that separates one or both of the channels 210, 212 from the exterior of the elongated cylinder 202. In an example, shown in FIG. 10, the elongated cylinder 202 can include structural supports 219 that extend between the interior wall 214 and the outer wall 216 so that the elongated cylinder 202 can maintain structural integrity after the elongated cylinder 202 is inserted into the high-temperature vessel. For example, the structural supports 219 can ensure that the channels 210, 212 remain open so that flow of the spray liquid and the compressed air is not interrupted or impeded during operation. The structural supports 219 can also help the elongated cylinder 202 maintain rigidity and strength in response to thermally induced expansion and contraction as the spray nozzle 200 is inserted and removed from the high-temperature vessel and/or as the temperature within the high-temperature vessel is changed.

In the example shown in FIG. 8-10 (and best seen in FIG. 10), the liquid channel 210 and the air channel 212 are concentric or substantially concentric (e.g., sharing the same central axis 218, which can also be the same central axis 218 as the elongated cylinder 202 as a whole, or wherein a central axis of the liquid channel 210 is proximate to a central axis of the air channel 212 within a specified threshold distance) such that one of the channels 210, 212 is generally in the middle of the elongated cylinder 202 and the other of the channels 210, 212 at least partially surrounds the middle channel. In the example shown in FIG. 8-10, the liquid channel 210 is the middle channel and the air channel 212 surrounds the liquid channel 210 (e.g., with the interior wall 214 between the middle liquid channel 210 and the surrounding air channel 212), but in some applications, it may be preferable to have the air channel run along the middle of the elongated cylinder 202 and the liquid channel at least partially surrounds the middle air channel (in other words, the reverse of what is shown in FIG. 8-10).

Those having skill in the art will appreciate that non-concentric positioning of the channels 210, 212 can be used without varying from the scope of the present disclosure, such as a side-by side configuration with the liquid channel 210 extending generally along one lateral half of the elongated cylinder 202 and with the air channel 212 extending generally along the other lateral half of the elongated cylinder 202. Those having skill in the art would appreciate that such a configuration may require different placement of the inlets for the spray liquid and the compressed air (discussed below), but such design considerations are well within the skills of those having ordinary skill in the art.

In the example shown in FIG. 6-11 (and best seen in FIG. 10), the elongated cylinder 202, the liquid channel 210, the air channel 212, and the walls 214, 216 have a circular cross section. However, those having skill in the art will appreciate that cross-sectional shapes other than circular or even round shapes can be used without varying from the scope of the present disclosure. For example, the elongated cylinder 202 could have a rectangular cross section and one or both of the channels 210, 212 could have a circular or round cross section; or the elongated cylinder 202 could have a circular or round cross section and one or both of the channels 210, 212 could have a rectangular or other polygonal cross section; or all three of the elongated cylinder 202, the liquid channel 210, and the air channel 212 can all have a non-round and/or polygonal cross section (such as a rectangular, square, triangular, pentagonal, hexagonal, or any other regular or irregular polygon cross section), wherein the cross sectional shapes of the elongated cylinder 202 and the channels 210, 212 can be the same or different from one another.

In the example shown in FIG. 6-8, the spray nozzle 200 includes inlets for the spray liquid and the compressed air that are separate from one another (as opposed to the example of the spray nozzle 200 of FIG. 3-5, wherein both the spray liquid and the compressed air are fed into the inner bore 142 of the atomizing tube 124 via a common venturi 126). The separate inlets can allow the spray liquid to be fed into the designated liquid channel 210 and compressed air to be fed into the air channel 212, wherein each channel 210, 212 is positioned within the elongated cylinder 202. In the example embodiment shown in FIG. 6-11 (and best seen in FIG. 8), the spray nozzle 200 includes a first inlet 220 that is in fluid communication with a first one of the liquid channel 210 or the air channel 212 and a second inlet 222 that is fluid communication with the other of the liquid channel 210 and the air channel 212. In the example shown in FIG. 8, the first inlet 220 is in fluid communication with the liquid channel 210 and, therefore, will also be referred to as “the spray liquid inlet 220,” and the second inlet 222 is in fluid communication with the air channel 212 and, therefore, will also be referred to as “the compressed air inlet 222.” As will be apparent, the spray liquid inlet 220 allows a supply line for the spray liquid (similar to the liquid feed line 144 in FIG. 4) to supply the spray liquid to the liquid channel 210 and the compressed air inlet 222 allows a supply line for compressed air (similar to the air feed line 146 in FIG. 4) to supply the compressed air to the air channel 212.

Each inlet 220, 222 can include one or more connection structures configured to couple each feed line to its corresponding inlet 220, 222. For example, the spray nozzle 200 can include a first connection structure at or proximate to the spray liquid inlet 220 to couple a liquid feed line (e.g., similar to the liquid feed line 144), also referred to as “the liquid feed connection structure” and a second connection structure at or proximate to the compressed air inlet 222 to couple a compressed air feed line (e.g., similar to the air feed line 146), also referred to as “the air feed connection structure.” Examples of structures that can be used for one or both of the liquid feed connection structure and the air feed connection structure include, but are not limited to, threading that corresponds to mating threading on the corresponding feed line (similar to the threading 132 on the atomizing tube 124 and the mating threading 134 on the venturi 126, described above), a compression fitting (such as the liquid compression fitting 148 and the air compression fitting 150 on the venturi 126, described above), a flange and gasket connection, a flange and o-ring connection, or an o-ring and clamp connection.

In the example embodiment shown in FIG. 6-8, the liquid feed connection structure comprises threading 224 on the elongated cylinder 202 at the proximal end 204 (e.g., male threading 224 on an outer surface of the elongated cylinder 202 at the proximal end 204, as shown in FIG. 6-8). The threading 224 can be configured to engage with mating threading on a spray liquid feed line or on another structure that is in fluid communication with the spray liquid feed line so that the spray liquid feed line will be in fluid communication with the liquid channel 210 via the spray liquid inlet 220. In the example embodiment shown in FIG. 6-8 and 11, the air feed connection structure comprises a stem 226 that can be connected to a compressed air feed line (such as via compression fitting between the compressed air feed line and the stem 226) so that the compressed air feed line will be in fluid communication with the air channel 212 via the compressed air inlet 222.

The channels 210, 212 each provide a fluid conduit between the inlet 220, 222 and a corresponding fluid outlet at the distal end 206 of the elongated cylinder 202. For example, the liquid channel 210 provides a fluid path from the spray liquid inlet 220 at or proximate to the proximal end 204 of the elongated cylinder 202 to a spray liquid outlet 230 at the distal end 206, and the air channel 212 provides a fluid path from the compressed air inlet 222 at or proximate to the proximal end 204 to a compressed air outlet 232 at the distal end 206. In an example, the spray liquid outlet 230 and the compressed air outlet 232 are located proximate to one another at the distal end 206 so that compressed air exiting the compressed air outlet 232 will act to atomize the spray liquid exiting the spray liquid outlet 230 into a mist having a desired droplet size and a desired droplet dispersal. This is in slight contrast to the spray nozzle 120 of FIG. 3-5, wherein compressed air is mixed with the spray liquid in the venturi 126 (e.g., in the mixing conduit 140), so that atomization of the spray liquid is at least started in the venturi 126 and at the proximal end 128 of the atomizing tube 124. In other words, the spray nozzle 200 is configured so that compressed air that flows out of the compressed air outlet 232 at relatively high velocity and interferes with the spray liquid stream exiting from the spray liquid outlet 230 to atomize the spray liquid outside of the spray nozzle 200.

In an example, the air channel 212 includes a tapered portion 234 where the width of the air channel 212 decreases abruptly immediately upstream of the compressed air outlet 232 so that the direction of flow of the compressed air exiting the compressed air outlet 232 is angled inward toward the spray liquid stream that is exiting the spray liquid outlet 230 (which, in an example would be flowing generally axially out of the spray liquid outlet 230 parallel or substantially parallel to the central axis 218).

Turning back to the liquid feed connection structure, e.g., the threading 224, although it is described above as being configured to receive only the spray liquid into the spray liquid inlet 220, those having skill will appreciate that the liquid feed connection structure and the spray liquid inlet 220 are not necessarily limited to this configuration. For example, the threading 224 on the proximal end 204 of the elongated cylinder 202 can be similar or identical to the threading 132 at the proximal end 128 of the atomizing tube 124 such that the threading 224 can be engaged with corresponding mating threading of a venturi (e.g., similar or identical to the mating threading 134 of the venturi 126 described above). In fact, the threading 224 can be configured to fit in the exact same venturi 126 or one that is substantially similar. In such an embodiment, the venturi 126 would not only supply the spray liquid to the liquid channel 210, but would also mix compressed air into the spray liquid stream as it is fed into the liquid channel 210, e.g., so that the spray liquid stream that is flowing through the liquid channel 210 is “pre-atomized” by the venturi 126 similar to the spray liquid and compressed air mixing described above for the venturi 126 and the spray nozzle 120. The pre-atomizing by the venturi 126 at the proximal end 204 of the spray nozzle 200 can then be completed by the compressed air exiting the compressed air outlet 232 proximate to the spray liquid outlet 230 at the distal end 206 of the elongated cylinder 202, described above. In this way, the configuration of the spray nozzle 200 with the separate internal channels 210, 212 for the spray liquid and the compressed air can offer more flexibility in the control of the atomization of the spray liquid.

In an example, a length L_{Cyl} of the elongated cylinder 202 (FIG. 6) can be similar or identical to the length L_{Tube} of the atomizing tube 124 for the spray nozzle 120. For example, the length L_{Cyl} can be long enough so that the spray nozzle 200 can be inserted entirely through a thick wall of a high-temperature vessel, such as a calcination furnace, so that the spray liquid outlet 230 and the compressed air outlet 232 are at a desired location within the interior of the high-temperature vessel so that the mist of the spray liquid that is exiting the spray nozzle 200 will be located at a desired position to achieve a desired effect (e.g., so that the one or more hydrated aluminum salt compounds in the spray liquid are calcined to form alumina powder 80, 92 within the high-temperature vessel. In an example, the length L_{Cyl} of the elongated cylinder 202 is from about 500 mm (about 19.7 inches) to about 650 mm (about 25.6 inches), such as from about 525 mm (about 20.7) to about 590 mm (about 23.3 inches), such as from about 550 mm (about 21.6 inches) to about 580 mm (about 22.8 inches), such as about 560 mm (about 22 inches), however the ideal length L_{Cyl} may depend on other factors including, but not limited to, the specific spray liquid (e.g., the compound or compounds that are present in the spray liquid), a concentration of the component or components in the spray liquid (when the spray liquid is a solution), the pressure of the compressed air, the flow rates of the spray liquid and the compressed air, and the desired extent of atomization.

In an example, a width in the largest lateral direction of the elongated cylinder 202, such as an outer diameter OD_{Cyl} if the elongated cylinder 202 has a circular cross section (see FIG. 6), can be similar or identical to the width in the largest lateral direction of the atomizing tube 124 (e.g., the OD_{Tube}). For example, the outer diameter OD_{Cyl} of the elongated cylinder 202 can be selected to be small enough to fit within a relatively small opening in the wall of the high-temperature vessel, such as a calcination furnace. In an example, the outer diameter OD_{Cyl} or other width in the widest lateral direction of the elongated cylinder 202 is from about 6 mm (about ¼ inch) to about 60 mm (about 2½ inch), such as from about 7.5 mm (about 0.3 inch) to about 50 mm (about 2 inch), for example from about 10 mm (about 0.4 inch) to about 40 mm (about 1½ inch), such as from about 12.5 mm (about ½ inch) to about 32 mm (about 1¼ inch), for example from about 15 mm (about 0.6 inch) to about 25 mm (about 1 inch), for example from about 16.5 mm (about 0.65 inch) to about 23 mm (about 0.9 inch), such as about 19 mm (about ¾ inch).

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A spray nozzle comprising:
an elongated cylinder comprising a first end, an opposite second end, and a conduit extending between the first end and the second end;
wherein the first end is configured for receiving a liquid based composition and a compressed gas,
wherein the second end comprises at least one outlet for the liquid based composition and the compressed gas, and
wherein the elongated cylinder is formed from a first ceramic material that can withstand temperatures of at least 500° C. and that will not corrode when exposed to the liquid based composition.

2. The spray nozzle of claim 1, wherein the elongated cylinder comprises a connection structure at the first end configured to couple to a fixture.

3. The spray nozzle of claim 2, wherein the fixture is configured to couple to the connection structure and to at least one feed line configured to supply one or both of the liquid based composition and the compressed gas.

4. The spray nozzle of claim 2, wherein the fixture comprises a venturi comprising a corresponding mating structure for coupled with the connection structure of the elongated cylinder, a first feed line connector configured to couple to a first feed line that supplies the liquid based composition, and a second feed line connector configured to couple to a second feed line that supplies the compressed gas.

5. The spray nozzle of claim 4, wherein the venturi comprises a first conduit in fluid communication between the first feed line connector and the corresponding mating structure and a second conduit in fluid communication between the second feed line connector and the corresponding mating structure, wherein the first conduit and the second conduit join to mix the liquid based composition with the compressed gas.

6. The spray nozzle of claim 1, wherein
the first ceramic material comprises at least one of: silicon nitride, graphite, silicon carbide, sintered alumina, zirconia, and boron nitride.

7. The spray nozzle of claim 1, further comprising a spray tip coupled to the elongated cylinder at the second end.

8. The spray nozzle of claim 7, wherein the elongated cylinder comprises a widened section configured to receive the spray tip.

9. The spray nozzle of claim 7 further comprising a high-temperature resistant cement that secures the spray tip to the elongated cylinder.

10. The spray nozzle of claim 7, wherein the spray tip is formed from a second ceramic material that can withstand temperatures of at least 500° C. and that will not corrode when exposed to the liquid based composition.

11. The spray nozzle of claim 10, wherein the second ceramic material comprises at least one of: silicon nitride, graphite, silicon carbide, sintered alumina, zirconia, and boron nitride.

12. The spray nozzle of claim 1, wherein the first ceramic material can withstand temperatures of at least 750°C.

13. (canceled)

14. The spray nozzle of claim 1, wherein the first ceramic material can withstand temperatures of from about 500° C. to about 1300°C.

15. (canceled)

16. The spray nozzle of claim 1, wherein the liquid based composition comprises at least one of: a liquid comprising one or more liquid compounds, a solution comprising one or more solute compounds dissolved in a solvent; and a slurry comprising particles of one or more solid compounds suspended in a slurry medium.

17. The spray nozzle of claim 16, wherein the liquid based composition comprises the liquid and wherein the one or more liquid compounds are corrosive.

18. The spray nozzle of claim 16, wherein the liquid based composition comprises the solution and wherein one or both of the one or more solute compounds and the solvent are corrosive.

19. (canceled)

20. The spray nozzle of claim 16, wherein the liquid based composition comprises the slurry and wherein one or both of the one or more solid compounds and the slurry medium are corrosive.

21. The spray nozzle of claim 1, wherein
the liquid based composition comprises an acid, and/or
the compressed gas comprises compressed air.

22. (canceled)

23. The spray nozzle of claim 1, wherein the elongated cylinder comprises a first channel for passing the liquid based composition from a first inlet at the first end to a first outlet at the second end and a second channel for passing the compressed gas from a second inlet at the first end to a second outlet at the second end.

24. The spray nozzle of claim 23, wherein the second outlet is proximate to the first outlet so that the compressed gas exiting the second outlet will act to at least partially atomize the liquid based composition after exiting the first outlet.
